(19) United States
(12) Patent Application Publication
(10) Pub. No.: US 2001/0006558 A1
(43) Pub. Date: Jul. 5, 2001

(54) Failure analysis method, compression threshold deriving method, and recording medium

(75) Inventor: Fumihito Ohta, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Tokyo (JP)

(21) Appl. No.: 09/748,228

(22) Filed: Dec. 27, 2000

(30) Foreign Application Priority Data
Dec. 27, 1999 (JP) P11-370064

(51) Int. Cl. G06K 9/00; G06K 9/36; G06K 9/46

(52) U.S. Cl. 382/145; 382/232

(57) ABSTRACT

Provided are a failure analysis method with which it is able to prevent incorrect recognition of fail shapes and to recognize and classify fail shapes at high accuracy, and a recording medium for recording its program, as well as a method of deriving compression thresholds used in the failure analysis method, and a recording medium for recording its program. Specifically, a recognition rule is read (ST1), and a plurality of compressed FBMs, i.e., fail bit maps, are prepared (ST2). After selecting an inferior recognition object (ST3), a predetermined region is selected based on the setting of a fail size (ST4), and the fail rate in the predetermined region is calculated (ST5). Subsequently, under the fail rate condition and the condition as to whether an inferior recognition object is adjacent or not, the inferior recognition object is estimated (ST6), and the fail rates of the remaining compressed FBMs are calculated and normalized (ST7). The fail shape is distinguished by collating the fail rates of their respective compressed FBMs to the fail shape judgement rule.

### BACKGROUND OF THE INVENTION

1. Field of the Invention

The present invention relates to a failure analysis of semiconductor devices and, in particular, to a failure analysis method on the wafer of a semiconductor device having a plurality of memory cells, and a recording medium for recording its program, as well as a method of deriving compression thresholds, and a recording medium for recording its program.

2. Description of the Background Art

As a method of performing on a wafer a failure analysis of a semiconductor device having a plurality of memory cells (generally disposed in matrix form), one which employs a tester (hereinafter referred to as “LSI tester”) has been known. In this method, an electrical characteristic inspection of each memory cell on a wafer is performed, and the detected position coordinate of a failure memory cell is indicated in the form of a bit map (generally called “fail bit map (FBM)”) in a coordinate region defined by x-coordinate along the row direction and y-coordinate along the column direction. The cause of failure is estimated on the basis of the inferior pattern of the FBM.

For estimating the cause of failure by using a FBM, usually, the fail shape is first recognized (specified) and then classified, depending on its shape, into “inferior block,” “inferior line,” and “inferior bit.”

As used herein, “inferior block” takes place mainly in the event of abnormality on a signal line common to a plurality of memory cells, which signal line is other than word lines and bit lines. The memory cells commonly connected to the signal line become inferior, resulting in such a shape that fail bits are closely gathered.

The “inferior line” takes place mainly in the event of abnormality on a word line or bit line, and a series of memory cells connected to the word line or bit line become inferior, resulting in such a shape that fail bits are aligned in a row or line direction.

The “inferior bit” takes place in the event of abnormality in the individual memory cells, resulting in such a shape that the memory cells are dotted with fail bits.

The FBM shape recognition has conventionally been conducted in the following manner. Specifically, a FBM is temporarily compressed according to a predetermined rule, and a rough shape recognition of the compressed FBM is performed to classify into “inferior block,” “inferior line” or “inferior bit.” Subsequently, a 1-bit level recognition of the recognized fail area is performed to recognize its detail shape (e.g., fail size).

As used herein, the term “to compress” denotes the following operation. One FBM is divided by a predetermined area, e.g., 64 bits of 8 bits on x-coordinate by 8 bits on y-coordinate, and, if a fail bit of 1 bit or more is present in the area of 64 bits, this 64 bits is converted into one fail pixel. On the other hand, if no fail bits are present in the area of 64 bits, this 64 bits is converted into one pass pixel. This example is hereinafter referred to as the case that the FBM is compressed by 8×8 bits.” The above-mentioned predetermined area is hereinafter referred to as “compression area.”

With this manner, however, due to variations in the density of failure, the recognition shape changes depending on the compression rate, thus causing an incorrect recognition.

Assume that in a FBM having a size of x×y=32 bits×32 bits, only the left side is dotted with fail bits FB, as viewed in FIG. 56. Such a FBM prior to compression, as shown in FIG. 56, is hereinafter referred to as “original FMB.”

The original FBM in FIG. 56 is divided by an 8×8 bit compression area, and then compressed, to obtain a 4×4 pixel matrix. Thereby, as shown in FIG. 57, the entire leftmost column of the pixel matrix becomes fail pixel FP, which indicates “inferior line.”

However, if the original FBM is compressed by 2×2 bits, this is divided into a 16×16 pixel matrix. Thereby, as shown in FIG. 58, the pixel matrix is dotted with fail pixels FP, which indicates “inferior bit.”

### SUMMARY OF THE INVENTION

A first aspect of the present invention is directed to a failure analysis method using an original fail bit map that is prepared, based on the data about the position of a failure memory cell having inferior electrical characteristic in a plurality of memory cells arranged in matrix form, by associating the failure memory cell with a fail bit in bit units, and mapping to the arrangement of the memory cells. The failure analysis method comprises the steps of: (a) preparing various compressed fail bit maps from the original fail bit map; and (b) calculating fail rates of the respective compressed fail bit maps and distinguishing a fail shape based on the fail rates, the compressed fail bit maps being prepared by the following steps: dividing the original fail bit map based on each of a plurality of compression areas having different size to convert into various forms in each of which a plurality of pixels of equal size to the their respective compression areas are arranged; and regarding the pixels containing the fail bit, as a fail pixel, and the fail rates being defined by the ratio of the fail pixel in a predetermined region.

A second aspect of the present invention is directed to a failure analysis method using an original fail bit map that is prepared, based on the data about the position of a failure memory cell having inferior electrical characteristic in a plurality of memory cells arranged in matrix form, by associating the failure memory cell with a fail bit in bit units, and mapping to the arrangement of the memory cells. The failure analysis method comprises the steps of: (a) preparing various compressed fail bit maps from the original fail bit map; and (b) calculating fail rates of the respective compressed fail bit maps and distinguishing a fail shape based on the fail rates, the compressed fail bit maps being prepared by the following steps: dividing the original fail bit map based on a predetermined compression area to convert into such a form that a plurality of pixels of equal size to the compression area; judging based on each of a plurality of compression thresholds defining the number of the fail bits in the pixels whether the pixels are fail, and regarding the pixels containing a number of the fail bits corresponding to their respective compression thresholds, as a fail pixel, and the fail rates being defined by the ratio of the fail pixel in a predetermined region.

A third aspect of the present invention is directed to a failure analysis method using an original fail bit map that is prepared, based on the data about the position of a failure memory cell having inferior electrical characteristic in a plurality of memory cells arranged in matrix form, by associating the failure memory cell with a fail bit in bit units, and mapping to the arrangement of the memory cells. The failure analysis method comprises the steps of: (a) preparing various compressed fail bit maps from the original fail bit map; and (b) calculating fail rates of the respective compressed fail bit maps and distinguishing a fail shape based on the fail rates, the compressed fail bit maps being prepared by the following steps: dividing the original fail bit map based on each of a plurality of compression areas having different size to convert into various forms in each of which a plurality of pixels of equal size to the their respective compression areas arranged; based on each of a plurality of compression thresholds defining the number of the fail bits in the pixel whether the pixels are fail, and regarding the pixels containing not less than a number of the fail bits corresponding to their respective compression thresholds, as a fail pixel, and the fail rates being defined by the ratio of the fail pixel in a predetermined region.

According to a fourth aspect of the present invention, in the method of any one of the first to third aspects, the step (b) includes the steps of: (b-1) by using as a reference fail rate the fail rate about one of the compressed fail bit maps, estimating a fail shape by collating at least a predetermined fail rate for distinguishing a fail shape with the reference fail rate; (b-2) obtaining index values for fail shape judgement by standardizing the fail rates of the rest of the compressed fail bit maps by using the reference fail rate as a denominator; and (b-3) collating the index values with a predetermined fail shape judgement rule to obtain a result, and distinguishing a fail shape based on the result and the result of the fail shape estimation in the step (b-1).

According to a fifth aspect of the present invention, in the method of the fourth aspect, the step (b) includes the step of judging whether the fail pixel in the predetermined region is adjacent to the fail pixel in a region other than the predetermined region, and the step (b-1) performs a fail shape estimation based on the result of the collation between the predetermined fail rate and the reference fail rate, and the result of the judging step.

A sixth aspect of the present invention is directed to a method of deriving a compression threshold used in a failure analysis method using an original fail bit map that is prepared, based on the data about the position of a failure memory cell having inferior electrical characteristic in a plurality of memory cells arranged in matrix form, by converting the failure memory cell with a fail bit in bit units, and mapping to the arrangement of the memory cells. The method of deriving a compression threshold comprises the steps of: (a) dividing the original fail bit map based on a predetermined compression area, and converting into such a form that a plurality of pixels of equal size to the compression area are arranged; (b) counting, per the pixel, the fail bits in the pixels; and (c) obtaining characteristic of existence of the fail bits that is expressed by the number of the pixels to the number of the fail bits in the pixels and, based on the characteristic of existence, thereby to calculate the compression thresholds.

According to a seventh aspect of the present invention, the step (c) includes the step of taking count of pixels starting when the number of the fail bits is 1, and adopting, as a compression threshold, the number of the fail bits when the number of the pixels first reaches a minimum value.

An eighth aspect of the present invention is directed to a computer readable recording medium for recording a program that allows a computer to execute a method of deriving compression thresholds of the sixth or seventh aspect.

A ninth aspect of the present invention is directed to a failure analysis method using an original fail bit map that is prepared, based on the data about the position of a failure memory cell having inferior electrical characteristic in a plurality of memory cells arranged in matrix form, by associating the failure memory cell with a fail bit in bit units, and mapping to the arrangement of the memory cells. The failure analysis method comprises the steps of: (a) preparing compressed fail bit maps from the original fail bit map; and (b) extracting the fail bits in a predetermined region in the compressed fail bit map as fail bits of the same group, the compressed fail bit map being prepared by the following steps of: dividing the original fail bit map based on each of a plurality of compression areas each having a predetermined size to convert into a form in which a plurality of pixels of equal size to their compression areas are arranged; judging based on each of a plurality of compression thresholds defining the number of the fail bits in the pixels whether the pixels are fail, and regarding the pixels containing not less than a number of the fail bits corresponding to their respective compression thresholds, as a fail pixel, and the step (a) includes the step of compressing the original fail bit map by using the compression threshold, the predetermined region being defined by predetermined number of the pixels, and the step (b) includes the step of judging the fail pixels in the predetermined number of pixels as pixels in the same group, and extracting the fail bits included in the group as bits in the same group.

According to a tenth aspect of the present invention, the method further comprises the step of, after the step (b), (c) preparing a processed original fail bit map by eliminating the fail bits extracted as the same group from the original fail bit map, wherein the steps (a) to (c) are repeated predetermined number of times to extract the fail bits of other group, and in the second and subsequent times, the step (a) prepares the compressed fail bit map based on the processed original fail bit map in place of the original fail bit map.

According to an eleventh aspect of the present invention, the method further comprises the step of (c) checking an involvement relation between the fail bit included in the same group and the fail bit in the other group after repeating the steps (a) and (b) predetermined number of times, wherein the step (c) includes the step of defining an involving group and an involved group by comparing coordinates of areas of forming the fail pixels constructing the groups in the compressed fail bit map.

A twelfth aspect of the present invention is directed to a failure analysis method using an original fail bit map that is prepared, based on the data about the position of a failure memory cell having inferior electrical characteristic in a plurality of memory cells arranged in matrix form, by associating a failure memory cell with a fail bit in bit units and mapping to the arrangement of the memory cells. The failure analysis method comprises the steps of: (a) preparing a compressed fail bit map from the original fail bit map; (b) preparing a repeatedly compressed fail bit map by further compressing the compressed fail bit map predetermined number of times; and (c) extracting the fail bits within a predetermined region in the repeatedly compressed fail bit map as fail bits of the same group, the compressed fail bit maps being prepared by the following steps: dividing the original fail bit map based on a first compression area each having a predetermined size to convert into a form in which the first pixel of equal size to the first compression area are arranged; judging based on the first compression threshold defining the number of the fail bits in the first pixel whether the first pixel is fail, and regarding the first pixel containing not less than a number of the fail bits corresponding to the first compression thresholds, as a first fail pixel, and the repeatedly compressed fail bit maps being prepared by the following steps: dividing the compression fail bit map based on a second compression area having a predetermined size; to convert into a form in which the second pixel of equal size to the second compression area are arranged; judging based on the second compression threshold defining the number of the first fail pixels in the second pixel whether the second pixel is fail, and regarding the second pixels containing not less than a number of the first fail pixels corresponding to the second compression thresholds, as a second fail pixel, and the step (a) includes the step of compressing the original fail bit map by using the first compression area and the first compression threshold, the step (b) includes the step of compressing the compressed fail bit map by using the second compression area and the second compression threshold, the predetermined region being defined by the predetermined number of the second pixels, and the step (c) includes the step of judging the second fail pixels existing within the predetermined number of pixels as pixels in the same group, and extracting the fail bits included in the group as bits in the same group.

According to a thirteenth aspect of the present invention, the method further comprises the step of (d) checking an involvement relation between the fail bit included in the same group and the fail bit in the other group after repeating the steps (a) to (c) preset number of times, wherein the step (d) includes the step of defining an involving group and an involved group by comparing coordinates of areas of forming the second fail pixels constructing each of the groups in the repeatedly compressed fail bit map.

According to a fourteenth aspect of the present invention, the method further comprises the step of displaying only the fail bits in the same group on a fail bit map.

According to a fifteenth aspect of the present invention, the method further comprises the step of simultaneously displaying the fail bits in the same group and the fail bits in the other group in different display colors on a fail bit map.

According to a sixteenth aspect of the present invention, the failure analysis method is conducted on a plurality of wafers, and further comprises the step of dividing each of the plurality of wafers into a plurality of concentrical annular-shaped areas by using a wafer center portion as a center area and counting the number of the fail bits in the same group and that of the fail bits in the other group existing in each of the plurality of concentrical annular-shaped areas of each of the plurality of wafers.

According to a seventeenth aspect of the present invention, the failure analysis method is conducted on a plurality of wafers, and further comprises the step of radially dividing each of the plurality of wafers into a plurality of areas every predetermined angle by using a wafer center portion as a center and counting the number of the fail bits in the same group and that of the fail bits in the other group in each of the plurality of radial areas in each of the plurality of wafers.

An eighteenth aspect of the present invention is directed to a computer readable recording medium for recording a program that allows a computer to execute a failure analysis method of any one of the first to fifth and ninth to thirteenth aspects.

With the failure analysis method of the first aspect, a plurality of compressed fail bit maps having different compression areas are made as compression conditions, and fail shapes are judged based on their respective fail rates. This enables to distinguish more kinds of fail shapes and increase the classifying accuracy of fail shape, as compared to the case that fail shapes are judged only by the fail rate of the compressed fail bit map formed under a single compression condition.

With the failure analysis method of the second aspect, a plurality of compressed fail bit maps having different compression thresholds are made as compression conditions, and fail shapes are judged based on their respective fail rates. This permits recognition taking the density of failure into consideration, and also enables to reduce incorrect recognition of fail shapes and increase the classifying accuracy of fail shape, as compared to the case that fail shapes are judged only by the fail rate of the compressed fail bit map prepared under a single compression condition.

With the failure analysis method of the third aspect, a plurality of compressed fail bit maps having different compression areas and different compression thresholds are made as compression conditions, and fail shapes are judged based on their respective fail rates. This enables to distinguish more kinds of fail shapes and increase the classifying accuracy of fail shape, as compared to the case of employing only a compression area or compression threshold as a compression condition.

With the failure analysis method of the fourth aspect, fail shapes are distinguished by collating the normalized fail rates to the fail shape judgement rule. Thereby, the setting values of the fail shape judgement rule can be made simple, thus facilitating the setting of the fail shape judgement rule.

With the failure analysis method of the fifth aspect, the estimating accuracy of fail shapes can be increased because, for example, “inferior line” can be estimated when no failure pixels are adjacent to that exists outside a predetermined region, and “inferior block” or “inferior bit” can be estimated when a failure pixel is adjacent to that exists outside the predetermined region.

With the method of deriving compression thresholds in the sixth aspect, a threshold value capable of ignoring any inferior bits occurred at random, can be obtained by calculating a compression threshold from the characteristic of existence of fail bits contained in a pixel.

With the method of deriving compression thresholds in the seventh aspect, a concrete compression threshold can be calculated from the characteristic of existence of fail bits.

The recording medium of the eighth aspect realizes a method of deriving a compression threshold capable of obtaining automatically a threshold value with which it is able to ignore any inferior bits occurred at random.

With the failure analysis method of the ninth aspect, whether the pixels are fail is judged based on their compression threshold, compressed fail bit maps are prepared regarding the pixels containing not less than a number of the fail bits corresponding to their respective compression thresholds, as a fail pixel, and the fail pixels in the predetermined number of pixel are judged in the same group and the fail bits in the group are extracted in the same group. This permits grouping of areas having different density of failure as different groups, and enables to identify the causes of failure by classifying fail shapes by the group after grouping.

With the failure analysis method of the tenth aspect, it further comprises a step (c) of preparing a processed original fail bit map by eliminating the fail bits extracted as the same group from the original fail bit map. After steps (a) to (c) are repeated predetermined number of times, in the second and subsequent times, the step (a) prepares the compressed fail bit map based on the processed original FBM in place of the original fail bit map. This permits consecutive grouping of only unprocessed groups, thereby grouping of each fail bits independently exists each other can be efficiently conduct.

With the failure analysis method of the eleventh aspect, an involvement relation between the fail bit included in the same group and the fail bit in the other group is defined after repeating the steps (a) and (b) predetermined number of times by comparing coordinates of areas of forming the fail pixels. This enables, for example, to know the distribution of density of the fail bits, thereby effective judgement material can be obtained for identifying the causes of failure.

With the failure analysis method of the twelfth aspect, original fail bit maps are divided based on a first compression area having a predetermined size, whether the pixels are fail is judged based on a first compression threshold, and compressed fail bit maps are prepared regarding the first pixel containing not less than a number of the fail bits corresponding to the first compression threshold, as a first fail pixel, compressed fail bit maps are divided based on a second compression area having a predetermined size; whether the pixels are fail is judged based on a second compression threshold, and repeatedly compressed fail bit maps are prepared regarding the second pixel containing not less than a number of the first fail pixels corresponding to the second compression threshold, as a second fail pixel. The second fail pixels in the predetermined number of fail pixels are judged in the same group and the fail bits included in the group are extracted as bits in the same group. This permits grouping of areas having different fail shapes as different groups, thereby enabling to identify the causes of failure efficiently by classifying fail shapes by the group after grouping.

With the failure analysis method of the thirteenth aspect, an involvement relation between the fail bit included in the same group and the fail bit in the other group is defined after repeating the steps (a) to (c) predetermined number of times by comparing coordinates of areas of forming the second fail pixels. This enables, for example, to know the positional relation of areas having different fail shapes, thereby effective judgement material can be obtained for identifying the causes of failure.

With the failure analysis method of the fourteenth aspect, by displaying only the fail bit in the same group on a fail bit map, judging based on each of a plurality of compression thresholds defining the number of said fail bits in said pixels whether said pixels are fail, and regarding said pixels containing not less than a number of said fail bits corresponding to their respective compression thresholds, as a fail pixel.

With the failure analysis method of the fifteenth aspect, by displaying the fail bit in the same group and the fail bit in the other group in different display colors on a fail bit map, judging based on each of a plurality of compression thresholds defining the number of said fail bits in said pixels whether said pixels are fail, and regarding said pixels containing not less than a number of said fail bits corresponding to their respective compression thresholds, as a fail pixel.

With the failure analysis method of the sixteenth aspect, each of the plurality of wafers is divided into a plurality of concentrical annular-shaped areas by using a wafer center portion as a center area and the number of the fail bits in the same group and that of the fail bits in the other group are counted in each of the plurality of concentrical annular-shaped areas in each of the plurality of wafer. This enables to visually recognize the statistical distribution of fail groups by presenting the above counting result in a graph.

With the failure analysis method of the seventeenth aspect, each of the plurality of wafers is divided into a plurality of radial areas every predetermined angle by using a wafer center portion as a center and the number of the fail bits in the same group and that of the fail bits in the other group are counted in each of the plurality of radial areas. This enables to visually recognize the statistical distribution of fail group by presenting the above counting result in a graph.

With the recording medium of the eighteenth aspect, when compared to the case that fail shapes are distinguished only by the fail rate of the compressed fail bit map prepared under a single compression condition, more kinds of fail shapes are distinguishable, thus realizing a failure analysis method with improved classifying accuracy of fail shapes. By preparing plurality of compressed fail bit maps with compression condition changed and extracting the fail bits in the predetermined number of bits in the same group, grouping of the fail bits is possible, thereby enabling to efficiently identify the cause of failures by classifying fail shapes by the group after grouping.

It is an object of the present invention to provide a failure analysis method with which it is able to prevent incorrect recognition of fail shapes and to recognize and classify fail shapes at high accuracy, and a recording medium for recording its program, as well as a method of deriving compression thresholds used in the failure analysis method, and a recording medium for recording its program.

Various failures occur at random on a wafer or densely in a certain area.

It is important to group failures densely occurring as a group in order to specify the cause of the failure. Conventionally, for example, a method of specifying a distance from a fail bit and grouping failures in the distance is adopted.

This method, however, has a problem such that when failure occurrence density varies, the specified distance has to be changed, and it is difficult to set the specified distance.

It is therefore a second object to provide a failure analysis method capable of easily grouping failures which occur densely.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating a system configuration for executing a failure analysis method according to the present invention;

FIG. 2 is a flow chart illustrating a failure analysis method according to a first preferred embodiment of the invention;

FIG. 3 is a diagram illustrating one example of recognition rules used in the above failure analysis method;

FIGS. 4A to 4C are diagrams of original FBMs illustrating the above failure analysis method;

FIGS. 5A to 5C, 6A to 6C and 7A to 7C are diagrams of compressed FBMs illustrating the above failure analysis method;

FIG. 8 is a flow chart illustrating a failure analysis method according to a second preferred embodiment;

FIG. 9 is a diagram illustrating one example of recognition rules used in the failure analysis method of the second preferred embodiment;

FIGS. 10A and 10B are diagrams of original FBMs illustrating the failure analysis method of the second preferred embodiment;

FIGS. 11A, 11B, 12A and 12B are diagrams of compressed FBMs illustrating the failure analysis method of the second preferred embodiment;

FIG. 13 is a flow chart illustrating a failure analysis method according to a third preferred embodiment;

FIG. 14 is a diagram illustrating one example of recognition rules used in the failure analysis method of the third preferred embodiment;

FIGS. 15A and 15B are diagrams of original FBMs illustrating a method of deriving compression thresholds according to a fourth preferred embodiment;

FIG. 16 is a flow chart illustrating the method of the fourth preferred embodiment;

FIGS. 17A, 17B and 18 are diagrams illustrating the method of the fourth preferred embodiment;

FIG. 19 is a diagram of an appearance of a computer system with which a failure analysis method of the invention is realized;

FIG. 20 is a diagram illustrating a construction of the above computer system;

FIG. 21 is a diagram showing an original FBM for explaining a failure analysis method of a fifth preferred embodiment;

FIG. 22 is a diagram specifically showing a part of the original FBM for explaining the failure analysis method of the fifth preferred embodiment;

FIG. 23 is a flow chart illustrating the failure analysis method of the fifth preferred embodiment;

FIG. 24 is a diagram showing a compressed FBM for explaining the failure analysis method of the fifth preferred embodiment;

FIG. 25 is a diagram showing a processed original FBM of the fifth preferred embodiment;

FIG. 26 is a diagram specifically showing a part of the original FBM for explaining the failure analysis method of the fifth preferred embodiment;

FIG. 27 is a diagram showing a compressed FBM for explaining the failure analysis method of the fifth preferred embodiment;

FIG. 28 is a diagram showing an original FBM of a sixth preferred embodiment;

FIG. 29 is a diagram specifically showing a part of the original FBM for explaining a failure analysis method of the sixth preferred embodiment;

FIG. 30 is a flow chart for explaining the failure analysis method of the sixth preferred embodiment;

FIG. 31 is a diagram showing a compressed FBM for explaining the failure analysis method of the sixth preferred embodiment;

FIG. 32 is a diagram showing a compressed FMB for explaining the failure analysis method of the sixth preferred embodiment;

FIG. 33 is a diagram showing the involvement relation of failure groups and a classification result of fail bit shapes;

FIG. 34 is a diagram showing an original FBM of a preferred seventh embodiment;

FIG. 35 is a diagram specifically showing a part of the original FBM for explaining a failure analysis method of the preferred seventh embodiment;

FIG. 36 is a diagram specifically showing a part of the original FBM for explaining the failure analysis method of the seventh preferred embodiment;

FIG. 37 is a flow chart for explaining the failure analysis method of the seventh preferred embodiment;

FIG. 38 is a flow chart for explaining the failure analysis method of the seventh preferred embodiment;

FIG. 39 is a diagram showing a compressed FBM for explaining the failure analysis method of the seventh preferred embodiment;

FIG. 40 is a diagram specifically showing a part of the compressed FBM for explaining the failure analysis method of the preferred seventh embodiment;

FIG. 41 is a diagram showing a repeatedly compressed FBM for explaining the failure analysis method of the seventh preferred embodiment;

FIG. 42 is a diagram showing a compressed FBM for explaining the failure analysis method of the seventh preferred embodiment;

FIG. 43 is a diagram specifically showing a part of the compressed FBM for explaining the failure analysis method of the seventh preferred embodiment;

FIG. 44 is a diagram showing a repeatedly compressed FBM for explaining the failure analysis method of the seventh preferred embodiment;

FIG. 45 is a diagram for explaining a method of deriving a compression threshold in an eighth preferred embodiment;

FIG. 46 is a diagram showing a processed original FBM in an example of displaying a failure analysis result;

FIG. 47 is a diagram showing a processed original FBM in an example of displaying a failure analysis result;

FIG. 48 is a diagram specifically showing a part of the processed original FBM in an example of displaying a failure analysis result;

FIG. 49 is a diagram specifically showing a part of the processed original FBM in an example of displaying a failure analysis result;

FIG. 50 is a diagram showing area division of a wafer used to calculate a failure analysis result;

FIG. 51 is a graph showing a failure analysis result;

FIG. 52 is a graph showing a failure analysis result;

FIG. 53 is a diagram showing area division of a wafer used to calculate a failure analysis result;

FIG. 54 is a graph showing a failure analysis result;

FIG. 55 is a graph showing a failure analysis result;

FIG. 56 is a diagram showing an original FBM for explaining a problem of a conventional failure analysis method;

FIG. 57 is a diagram showing a compressed FBM for explaining a problem of a conventional failure analysis method; and

FIG. 58 is a diagram showing a compressed FBM for explaining a problem of a conventional failure analysis method.

### DESCRIPTION OF THE PREFERRED EMBODIMENTS

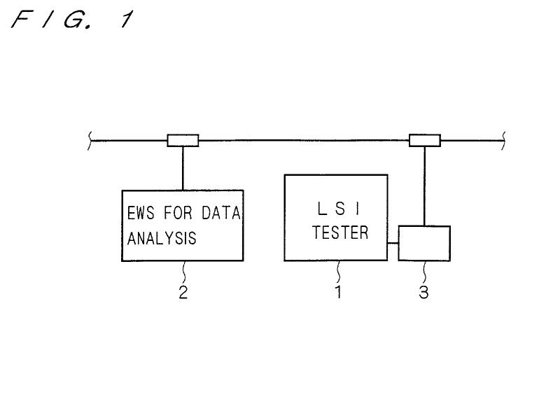

FIG. 1 shows a system configuration for executing a failure analysis method according to the present invention. In FIG. 1, an LSI tester 1, which performs an electrical characteristic inspection of all memory cells in a plurality of semiconductor devices disposed on a wafer, is connected via an interface 3 to an EWS (Engineering Work Station) for data analysis 2.

The data of the inspection result obtained by the LSI tester 1 is received and processed in the EWS for data analysis 2, by which the failure analysis method of the invention is executed.

A. First Preferred Embodiment

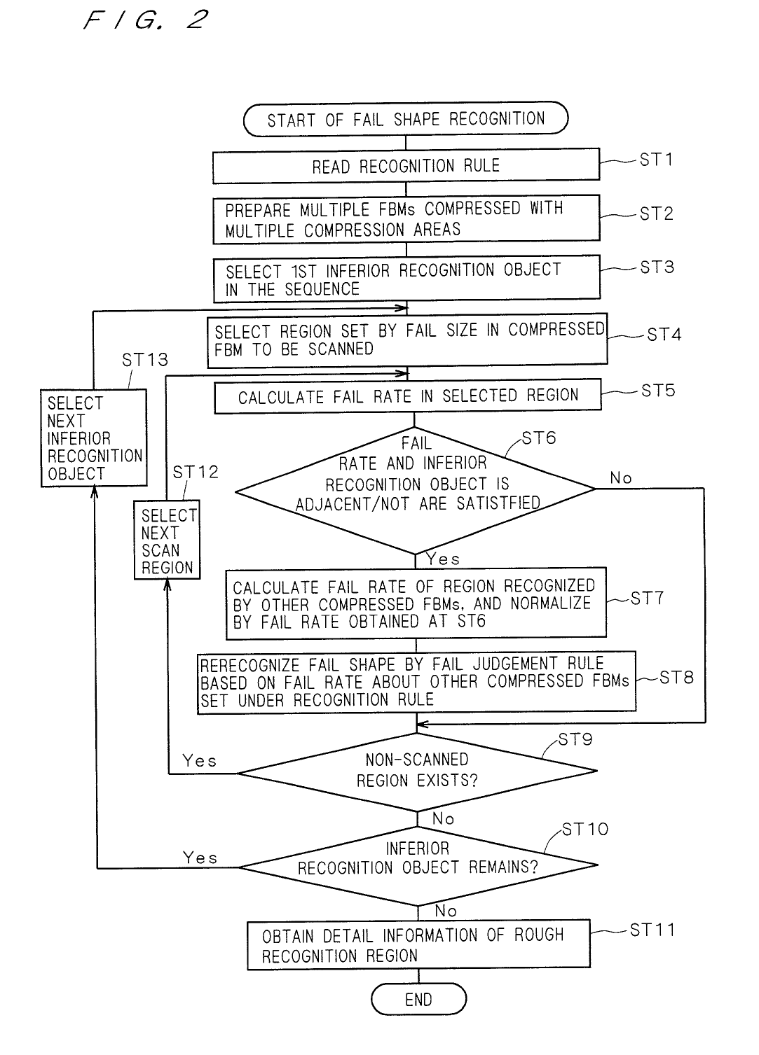

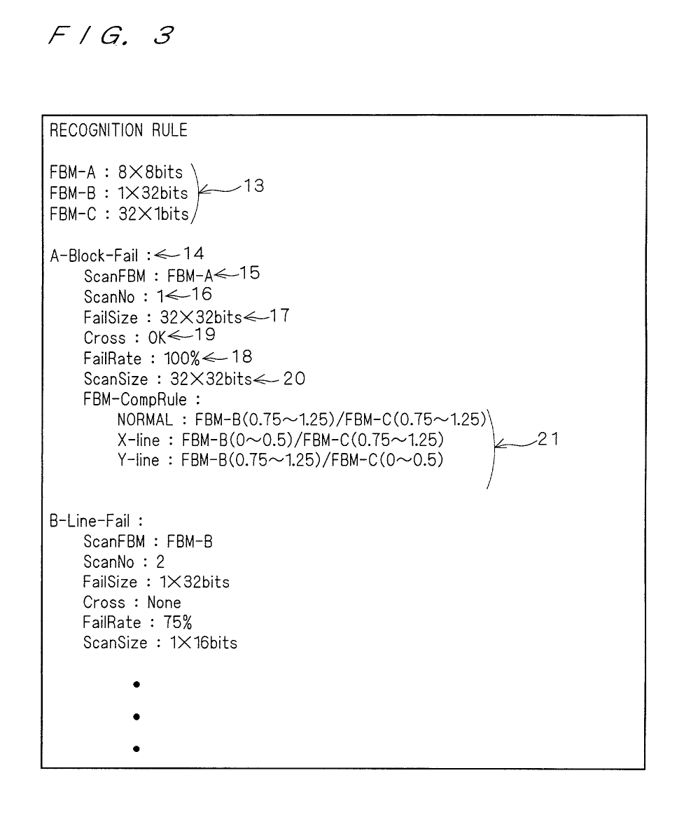

FIG. 2 is a flow chart illustrating a failure analysis method according to a first preferred embodiment. FIG. 3 is a diagram illustrating an example of failure shape recognition rules applied in executing the failure analysis method of this embodiment.

A-1. Recognition Rule

Referring now to FIG. 3, a fail shape recognition rule will be described. In FIG. 3, item 13 is an item for setting compression conditions. The case of changing compression areas is illustrated as compression conditions, and three compression areas of FBM-A (8×8 bits), FBM-B (1×32 bits) and FBM-C (32×1 bits) are set herein.

Item 14 is an item for setting the name of failure of a recognition object, such as “inferior block,” “inferior line” or “inferior bit.” “Inferior block” is set herein. The following items 15 to 21 are to be also set in the recognition of “inferior line” or “inferior bit.” In FIG. 3, “inferior block” is illustrated as an example.

Item 15 is an item for setting the name of a compressed FBM that serves as an object of failure analysis operation (called “scan”), i.e., a scan object. The “FBM-A” is selected herein.

Item 16 is an item for setting the recognition sequence of inferior recognition objects. It is so set that “inferior block” is recognized first.

Item 17 is an item for setting the maximum value of the fail size of an inferior recognition object. This is expressed by the number of bits of row (x) by column (y), and “32×32 bits” (i.e., a matrix with 32 rows and 32 columns) is set herein.

Item 18 is an item for setting a fail rate that is used for judging the recognition of an inferior recognition object. Here, it is set such as to judge inferior when the fail rate is 100%.

Item 19 is an item for setting whether an inferior recognition object is adjacent or not. Here, it is so set that an inferior recognition object is adjacent.

The expression “an inferior recognition object is adjacent” indicates the state that fail pixels are adjacent to each other in the exterior of a region defined by a fail size.

Item 20 is an item for setting a scan region per step (i.e., scan size). This is expressed by the number of bits of row (x) by column (y), and “32×32 bits” is set herein.

Item 21 is an item for setting a fail shape judgement rule based on the normalized fail rates about compressed FBMs other than a compressed FBM as a scan object, namely, about that compressed by other than the compression area of FBM-A. Under this rule, it is judged whether the fail shape is “inferior block (NORMAL),” or “inferior line aligned in x-direction (X-Line),” or “inferior line aligned in y-direction (Y-Line),” depending on the normalized fail rates obtained in the compression with FBM-B or FBM-C compression area.

Specifically, it is judged “inferior block” when the normalized fail rate obtained by the FBM-B compression area and that obtained by FBM-C compression area, are both in the range of 0.75 to 1.25. It is judged “x-direction inferior line” when the former and latter are in the range of 0 to 0.5 and 0.75 to 1.25, respectively. It is judged “y-direction inferior line” when the former and latter are in the range of 0.75 to 1.25 and 0 to 0.5, respectively.

A-2. Analysis Operation

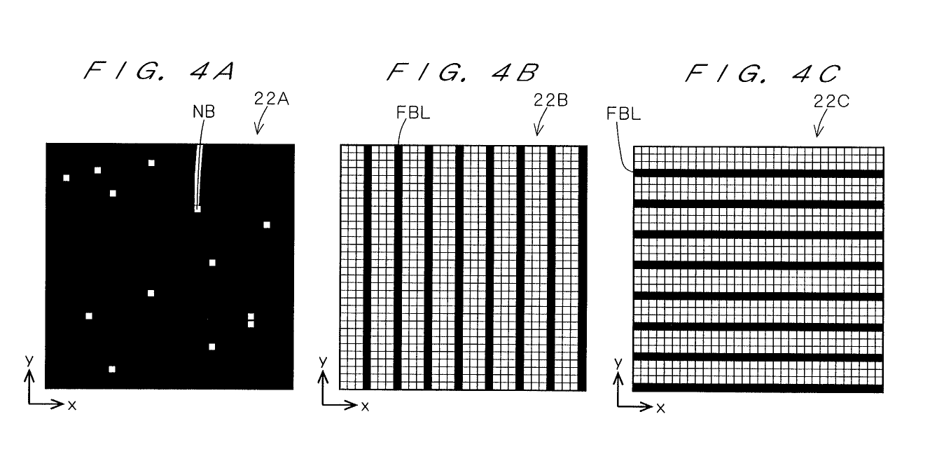

Failure analysis operation will be described by using FIG. 2, and by referring to FIG. 3 and FIGS. 4A, 4B, 4C, . . . 7A, 7B, 7C. FIGS. 4A to 4C are diagrams illustrating original FBMs which are prepared by mapping the data about the positions of the fail memory cells detected by the LSI tester 1 shown in FIG. 1, into a region that is divided by x×y=32 bits×32 bits. Specifically, FIGS. 4A, 4B and 4C show inferior patterns at different locations in a memory cell region, as FBMs 22A, FBM22B and FBM22C, respectively.

There are actually an enormous number of memory cells on a megabit or gigabit scale. It goes without saying that the region for forming an original FBM is much larger than 32 bits×32 bits.

The original FBM 22A shown in FIG. 4A is composed mostly of fail bits. When the fail bits in the figure are blackened, the figure is dotted with normal bits NB indicating a normal memory cell, as a blank space.

The original FBM 22B shown in FIG. 4B is in such a pattern that a plurality of fail bit lines FBLs, each being a series of fail bits aligned in y-direction, are located at 3-bit intervals in x-direction.

The original FBM 22C shown in FIG. 4C is in such a pattern that a plurality of fail bit lines FBLs, each being a series of fail bits aligned in x-direction, are located at 3-bit intervals in y-direction.

Analysis operation of the data about these original FBMs 22A, 22B and 22C will be described hereafter.

Referring now to FIG. 2, when a fail shape recognition is started, the recognition rule shown in FIG. 3, which is set depending on the type of a semiconductor device, is read first (step ST1).

Subsequently, the original FBMs 22A, 22B and 22C shown in FIGS. 4A, 4B and 4C are compressed based on the numerical values of compression areas, respectively, set at item 13 (compression area) in the recognition rule, thereby to make a plurality of compressed FBMs (step ST2). The above original FBMs 22A, 22B and 22C should be prepared before the fail shape recognition is started.

FIGS. 5A to 5C show compressed FBMs 23A, 23B and 23C, respectively, which are obtained by dividing the original FBMs 22A, 22B and 22C by the compression area of FBM-A (8×8 bits), followed by compression based on a compression threshold of 1 bit (not shown in the recognition rule).

When the original FBMs 22A, 22B and 22C shown in FIGS. 4A to 4C, respectively, are compressed to the area of 8×8 bits (64 bits), a fail bit is always present in every area of any FBMs, and thus all the areas become fail pixels. Therefore, when the fail pixels are blackened, all the areas are blackened as shown in FIGS. 5A to 5C.

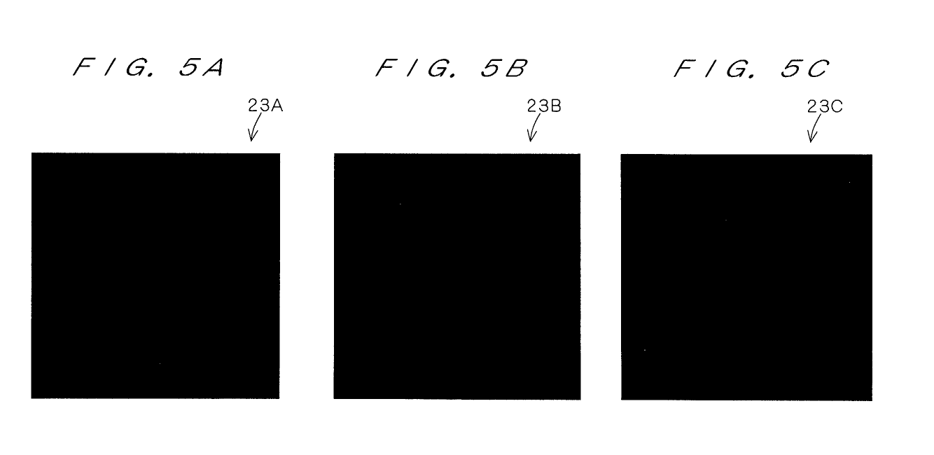

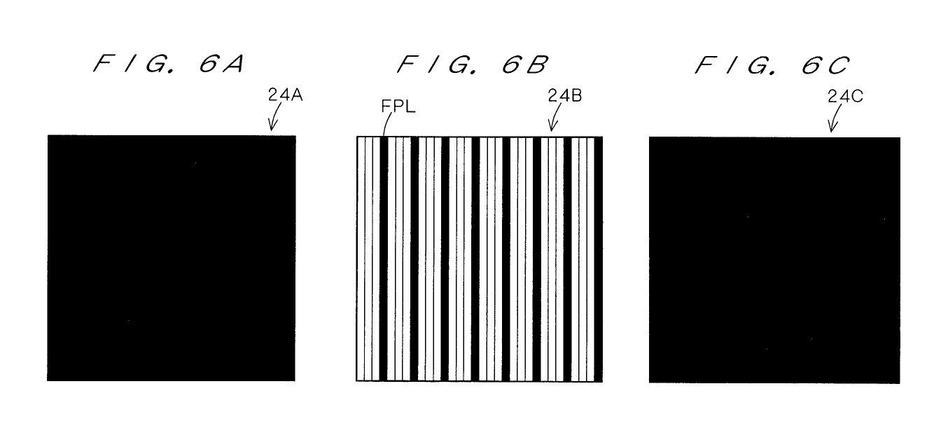

FIGS. 6A to 6C show compressed FBMs 24A, 24B and 24C, respectively, which are obtained by dividing the original FBMs 22A, 22B and 22C by the compression area of FBM-B (1×32 bits), followed by compression based on a compression threshold of 1 bit (not shown in the recognition rule).

When the original FBMs 22A, 22B and 22C shown in FIGS. 4A to 4C, respectively, are compressed to the area of 1×32 bits, namely, 1 bit in x-direction by 32 bits in y-direction, a fail bit is always present in every area of the original FBMs 22A and 22C, and thus all the areas become fail pixels. Therefore, when the fail pixels are blackened, all the areas are blackened as shown in FIGS. 6A and 6C. Whereas in the original FBM 22B, only the area corresponding to fail bit lines FBLs becomes a strip-like fail pixel FPL. This results in such a pattern that fail pixels FPLs are located at 3-bit intervals in x-direction, as shown in FIG. 6B.

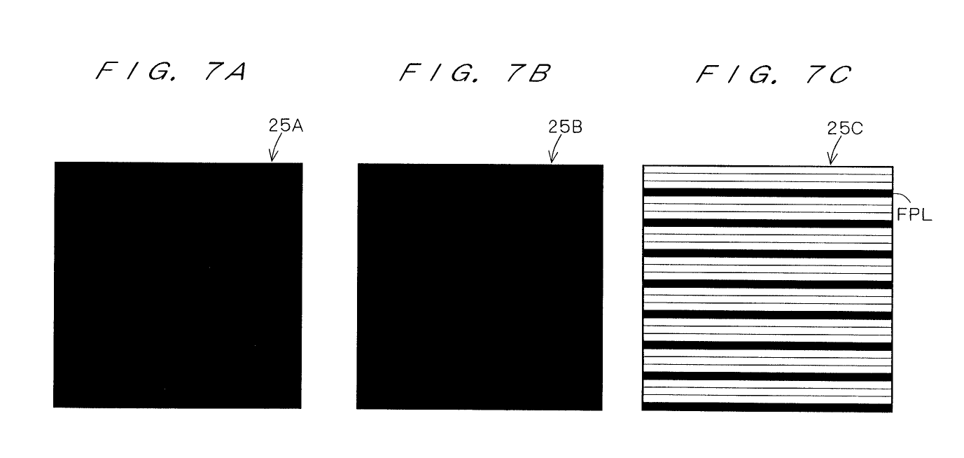

FIGS. 7A to 7C show compressed FBMs 25A, 25B and 25C, respectively, which are prepared by dividing the original FBMs 22A, 22B and 22C by the compression area of FBM-C (32×1 bits), followed by compression based on a compression threshold of 1 bit (not shown in the recognition rule).

When the original FBMs 22A, 22B and 22C shown in FIGS. 4A to 4C, respectively, are compressed to the area of 32×1 bits, namely, 32 bits in x-direction by 1 bit in y-direction, a fail bit is always present in every area of the FBMs 22A and 22B, and all the areas become fail pixels. Therefore, when the fail pixels are blackened, all the areas are blackened as shown in FIGS. 7A and 7B. Whereas in the original FBM 22C, only the area corresponding to a fail bit line FBL becomes a strip-like fail pixel FPL. This results in such a pattern that fail pixels FPLs are located at 3-bit intervals in y-direction, as shown in FIG. 7C.

Based on the setting at item 16 (the recognition sequence of inferior recognition objects) in the recognition rule, an inferior block (A-Block-Fail) is selected first as an inferior recognition object (step ST3).

Subsequently, based on the setting at item 15 (the name of a compressed FBM to be scanned) in the recognition rule, the compressed FBMs 23A, 23B and 23C, which have been compressed by the compression area of FBM-A, are selected. Then, based on the setting at item 17 (fail size), from the regions of the compressed FBMs 23A, 23B and 23C, the region of 32×32 bits is selected (step ST4).

It should be noted that in this preferred embodiment, the scan size set at item 20 is also 32×32 bits and thus matches the fail size, however, the fail size does not always match the scan size.

Subsequently, the fail rate in the region selected at step ST4 is calculated (step ST5).

The fail rate is expressed as a percentage of the value which is obtained by dividing the number of fail pixels in the compressed FBM by the number of pixels that corresponds to the fail size set at item 17. In the compressed FBMs 23A, 23B and 23C shown in FIGS. 5A to 5C, the number of fail pixels is 16, and the number of pixels that corresponds to the fail size is also 16, thereby the fail rate is 100%.

The fail pixel in the region selected at step ST4 is judged based on the judgement conditions of the fail rate (100%) set at item 18, and the presence of an adjacent inferior recognition object set at item 19 (whether or not an inferior recognition object is adjacent). When both judgement conditions are satisfied, the above fail pixel is recognized (estimated) as an inferior recognition object, i.e., “inferior block,” and it goes to the next step ST7. When these conditions are not satisfied, it goes to step ST9 (step ST6).

From the facts that the fail rates of the compressed FBM 23A, 23B and 23C of FIGS. 5A to 5C, are all 100%, that the fail rate set at item 18 is satisfied, and that the presence of an adjacent inferior recognition object is set at item 19, it is judged “inferior block,” and then goes to step ST7.

At step ST7, with respect to other compressed FBMs compressed by other than the compression area of FBM-A, the fail rate in the region selected at step ST4 is calculated and then normalized by the fail rate obtained at step ST5.

In the compressed FBMs 24A and 24C shown in FIGS. 6A and 6C, respectively, the number of fail pixels is 32, and the number of pixels in the region of 32×32 bits is also 32, thereby the fail rate is 100%. Normalization by 100% (the fail rate of the compressed FBMs 23A and 23C calculated at step ST5) results in that both are 1.

In the compressed FBM 24B shown in FIG. 6B, the number of fail pixels is 8, and the total pixel number is 32, thereby the fail rate is 25%. Normalization by 100% (the fail rate of the compressed FBM 23B) results in 0.25.

In the compressed FBMs 25A and 25B shown in FIGS. 7A and 7B, respectively, the number of fail pixels is 32, and the number of pixels in the region of 32×32 bits is also 32, thereby the fail rate is 100%. Normalization by 100% (the fail rate of the compressed FBMs 23A and 23B calculated at step ST5) results in that both are 1. In the compressed FBM 25C shown in FIG. 7C, the number of fail pixels is 8, and the number of pixels in the region of 32×32 bits is 32, thereby the fail rate is 25%. Normalization by 100% (the fail rate of the compressed FBM 23C) results in 0.25.

Subsequently, based on item 21 (the fail shape judgement rule based on the fail rates about compressed FBMs compressed by other than the compression area of FBM-A) in the recognition rule, the failure thus far recognized are rerecognized (step ST8).

Specifically, as to the original FBM 22A shown in FIG. 4A, when compressed with the compression area of FBM-B or FBM-C, the normalized fail rates are both 1. Therefore, based on the judgement rule using the normalized fail rates of FBM-B and FBM-C, at item 21, the original FBM 22A is rerecognized (specified) as “inferior block (NORMAL).”

As to the original FBM 22B shown in FIG. 4B, when compressed with the compression area of FBM-B or FBM-C, the normalized fail rates are 0.25 and 1, respectively. Therefore, it is rerecognized, or distinguished as “inferior line (X-Line) aligned in x-direction.”

As to the original FBM 22C shown in FIG. 4C, when compressed with the compression area of FBM-B or FBM-C, the normalized fail rates are 1 and 0.25, respectively. Therefore, it is rerecognized, or distinguished as “inferior line (Y-Line) aligned in y-direction.”

At step ST9, it is judged whether any non-scanned region remains in a semiconductor device. If remains, the next scan region (having area of 32×32 bits, which is set at item 20) is selected, and the operations of step ST5 and later steps are repeated (step ST12). If the entire region of the semiconductor device has been scanned, it goes to step ST10.

At step ST10, it is judged whether, of the inferior recognition objects set at the recognition rule shown in FIG. 3, any non-selected inferior recognition object remains or not. If remains, the next inferior recognition object is selected, and the operations of step ST4 and later steps are repeated (step ST13). If the entire region of the semiconductor device has been scanned, it goes to step ST1. Note that in accordance with the recognition rule shown in FIG. 3, “inferior block” (A-Block-Fail) is followed by “inferior line” (B-line-Fail), as an inferior recognition object. Hence, even for “inferior line,” the operations of step ST4 and later steps are to be repeated based on items 15 to 21.

At step ST11, the region recognized by the operations of steps ST3 to ST10 (rough recognition operations) is scanned at 1-bit level, to obtain detail information such as the actual fail size and the number of fail bits. Thereby, the fail shape recognition for one semiconductor device is completed.

Since a plurality of semiconductor devices are usually formed on a wafer, the operations of steps ST3 to ST11 should be performed per semiconductor device.

A-3. Resulting Effects

According to the failure analysis method of the first preferred embodiment as described, a plurality of compressed FBMs having different compression areas are prepared as compression conditions, and fail shapes are judged based on their respective fail rates. This enables to distinguish more kinds of fail shapes and increase the classifying accuracy of fail shapes, as compared to the case that fail shapes are judged only by the fail rate of the compressed FBM prepared under a single compression condition.

B. Second Preferred Embodiment

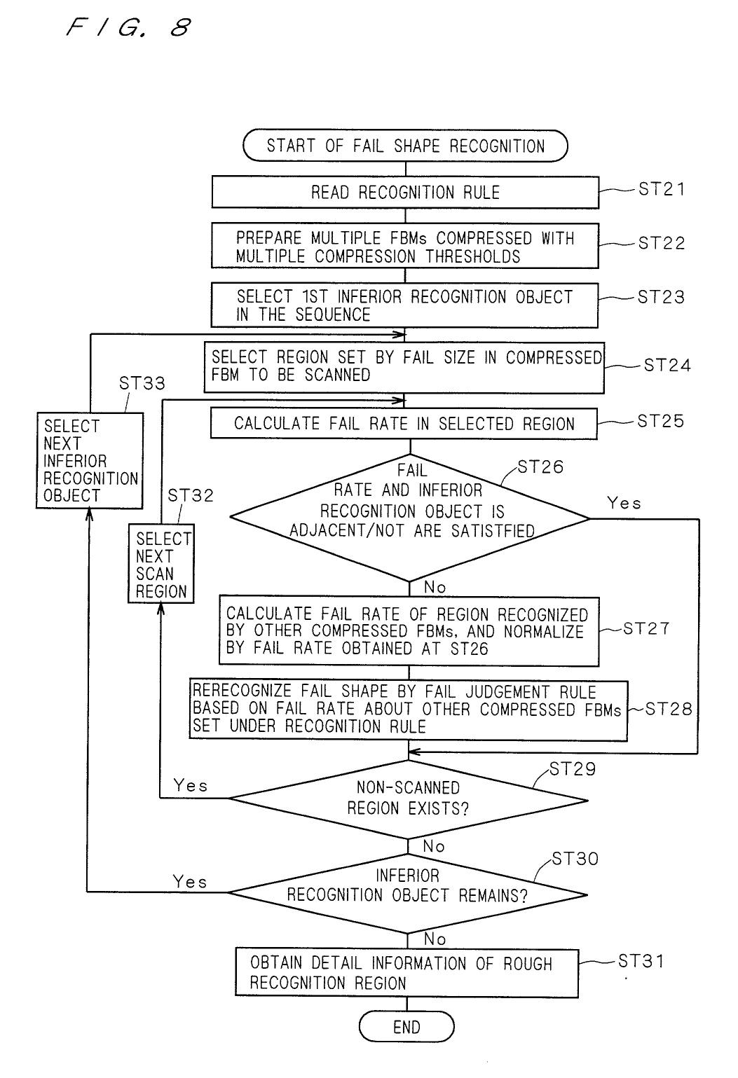

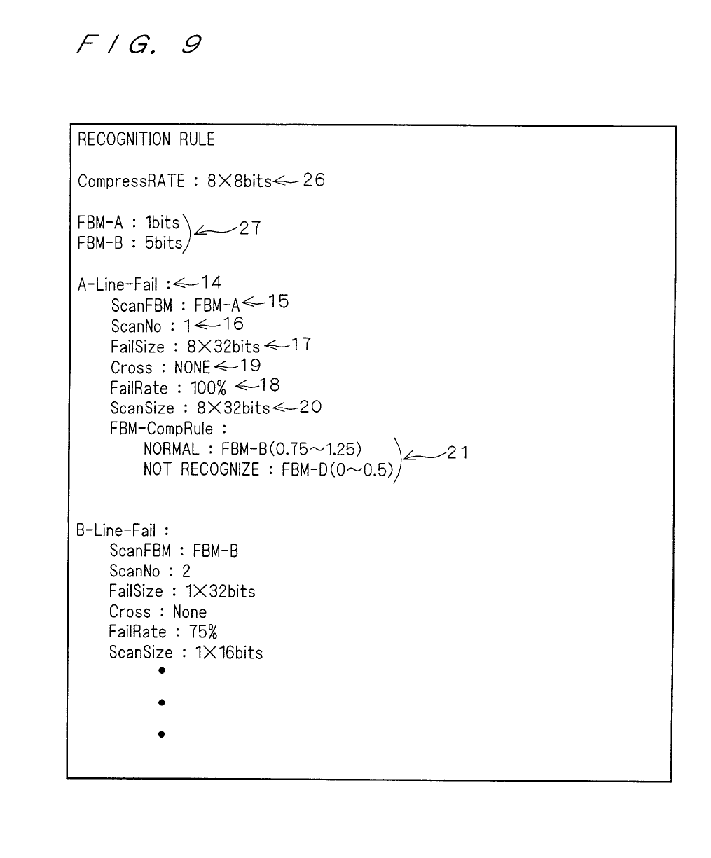

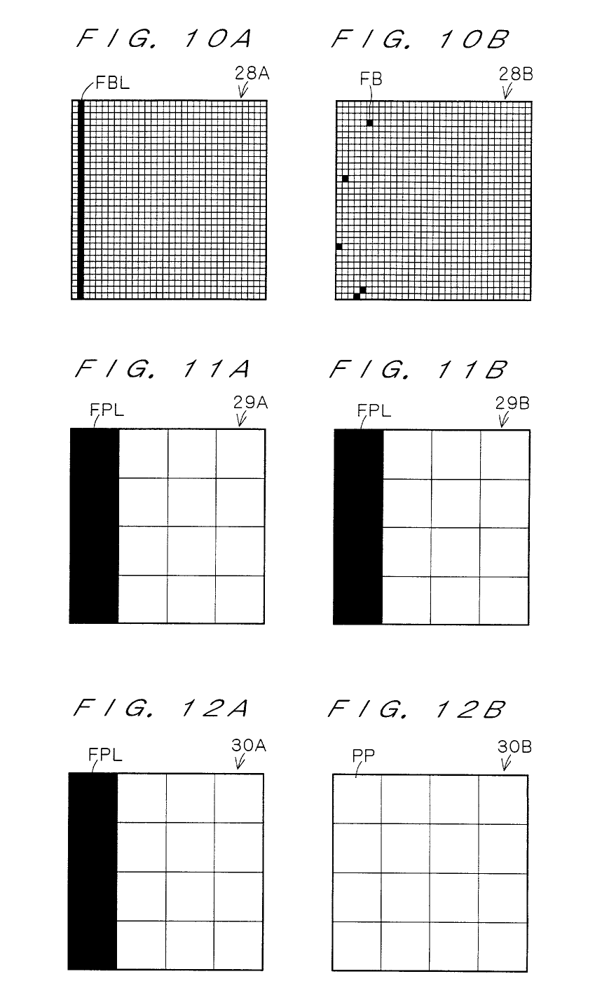

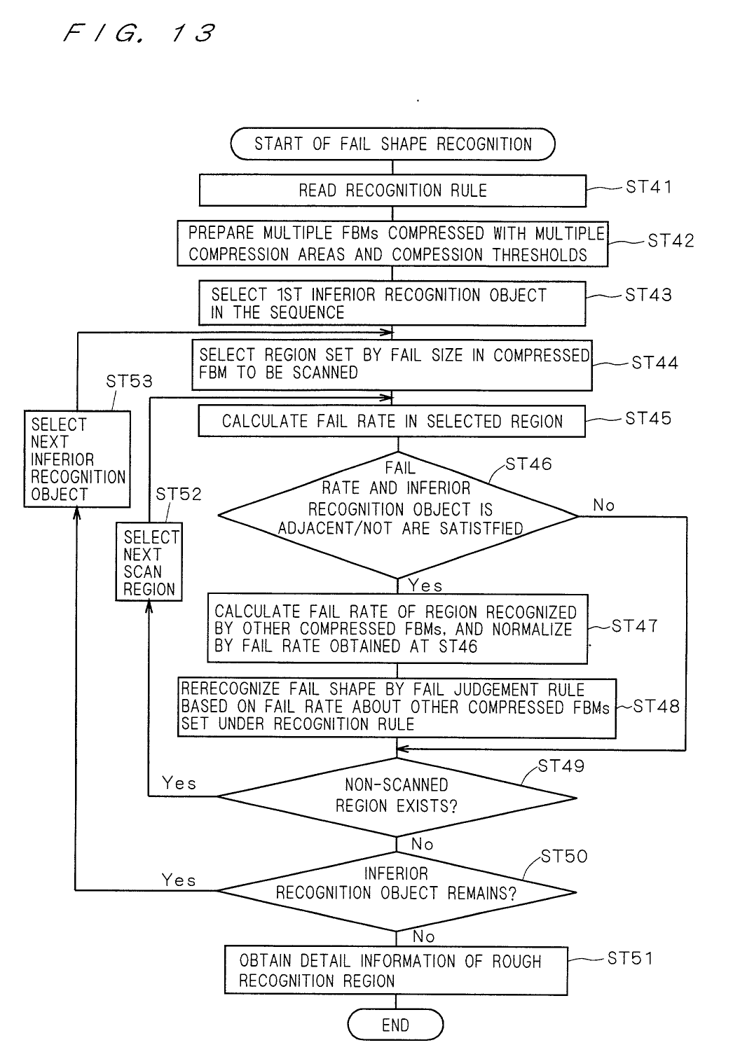

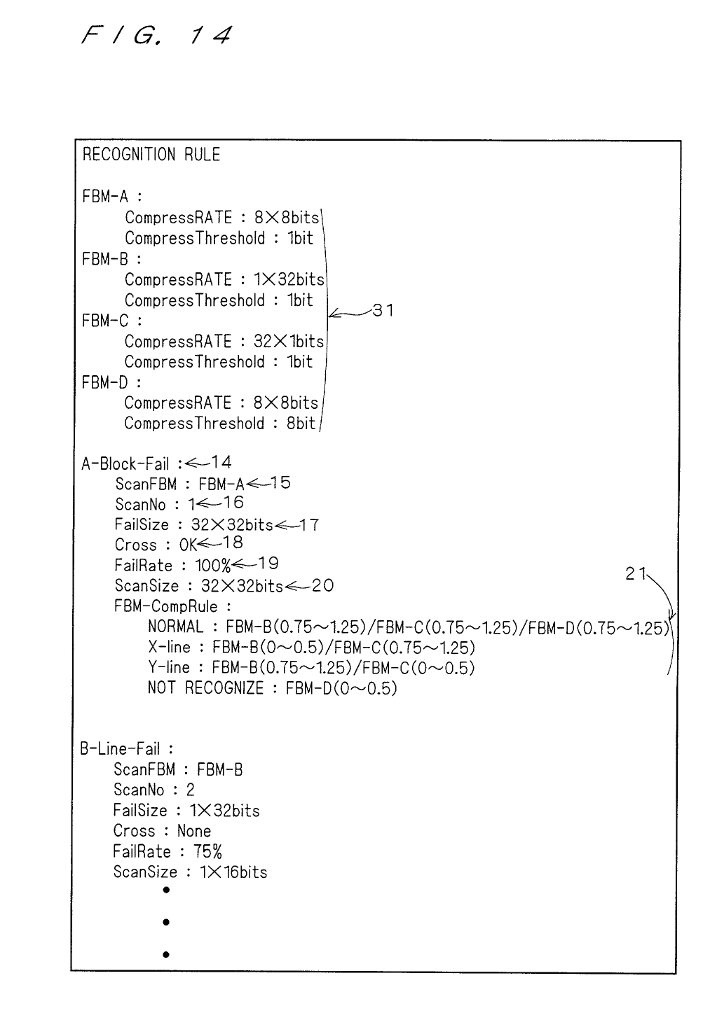

FIG. 8 is a flow chart illustrating a failure analysis method according to a second preferred embodiment. FIG. 9 is a diagram illustrating one example of fail shape recognition rules for executing the failure analysis method of this embodiment.

B-1. Recognition Rule

An inferior shape recognition rule will be described by referring to FIG. 9.

In FIG. 9, items 26 and 27 are items for setting compression conditions. This embodiment illustrates the case of changing a compression threshold that is one of the compression conditions. Only one compression area of 8×8 bits is set at item 26, whereas two compression thresholds of FBM-A (1 bit) and FBM-B (5 bits) are set at item 27.

As used herein, the term “compression threshold” means an index value to determine whether a predetermined compression area (pixel) is a pass pixel or fail pixel, and it is set as the number of fail bits existing in the predetermined compression area. For instance, in the event that the compression threshold is 1 bit, if one ore more fail bits are present in the compression area, it becomes a fail pixel.

Similar reference numerals have been used in the same items as the fail shape recognition rule for executing the failure analysis method in the first preferred embodiment described by referring to FIG. 3. The contents of their respective items are as follows:

At item 14 (the name of an inferior recognition object), “inferior line” is set. Referring to FIG. 8, “inferior line” will be described by way of example.

At item 15 (the name of a compressed FBM to be scanned), “FBM-A” is selected.

At item 16 (the recognition sequence of inferior recognition objects), it is so set that “inferior line” is recognized first.

At item 17 (the fail size of an inferior recognition object), “8×32 bits” (which means a matrix with 8 rows and 32 columns) is set.

At item 18 (fail rate), it is set so as to judge “fail” when the fail rate is 100%.

At item 19 (whether or not an inferior recognition object is adjacent), it is so set that no adjacent inferior recognition objects are present.

At item 20 (scan size), “8×32 bits” is set.

At item 21 (fail shape judgement rule), whether or not “inferior line (NORMAL)” is to be recognized is judged based on the fail rate normalized with use of the compression threshold of FBM-B.

For instance, it is judged “inferior line” when the fail rate thus obtained is in the range of 0.75 to 1.25, and judged “not recognize” when it is in the range of 0 to 0.5.

B-2. Analysis Operation

Failure analysis operation will be described by using FIG. 8, and referring to FIG. 9 and FIGS. 10A, 10B, . . . 12A and 12B. FIGS. 10A and 10B are diagrams illustrating original FBMs which are prepared by mapping the data about the positions of the fail memory cells detected by the LSI tester 1 shown in FIG. 1, into a region that is divided by x×y=32 bits×32 bits. That is, FIGS. 10A and 10B show two different inferior patterns, as original FBMs 28A and FBM28B, respectively.

The original FBM 28A of FIG. 10A is in such a pattern that a single fail bit line FBL composed of a series of fail bits aligned in y-direction is present in the vicinity of the left end as viewed in FIG. 10A.

The original FBM 28B of FIG. 10B is in such a pattern that only the left side as viewed in the figure is dotted with fail bits FB.

Analysis operation of the data about the original FBMs 28A and 28B will be described hereafter.

Referring to FIG. 8, when a fail shape recognition is started, the recognition rule shown in FIG. 9, which is set depending on the type of a semiconductor device, is read first (step ST21).

Subsequently, the original FBMs 28A and 28B shown in FIGS. 10A and 10B are respectively compressed based on the numerical values of compression areas set at item 26 (compression area) in the recognition rule. Hereat, by using, as an index, a plurality of compression thresholds set at item 27, a plurality of compressed FBMs are prepared (step ST22).

FIGS. 11A and 11B show compressed FBMs 29A and 29B, which are prepared by compressing the original FBMs 28A and 28B by the compression area (8×8 bits) set at item 26, based on the compression thresholds of FBM-A set at item 27, respectively.

When the original FBMs 28A and 28B of FIGS. 10A and 10B are compressed into the area of 8×8 bits (64 bits), both are divided into a 4×4 pixel matrix. When these are judged by the compression threshold of FBM-A (1 bit), the entire leftmost line of the pixel matrix becomes a fail pixel FPL. When the fail pixels are blackened, the leftmost line is blackened as shown in FIGS. 11A and 11B.

FIGS. 12A and 12B show compressed FBMs 30A and 30B, which are prepared by compressing the original FBMs 28A and 28B with the compression area (8×8 bits) set at item 26, based on the compression threshold of FBM-B set at item 27, respectively.

When the original FBMs 28A and 28B of FIGS. 10A and 10B are compressed into the area of 8×8 bits (64 bits), both are divided into a 4×4 pixel matrix, and compressed by the compression threshold of FBM-B (5 bits). As a result, as to the original FBM 28B in FIG. 10B, all the pixel matrixes become a pass pixel PP, as shown in FIG. 12B, because there exist no pixels having two or more fail bits.

Subsequently, based on the setting at item 16 (the recognition sequence of inferior recognition objects) in the recognition rule, inferior line (A-Line-Fail) is selected first, as an inferior recognition object (step ST23).

The compressed FBMs 29A and 29B that have been judged by the compression threshold of FBM-A are selected based on the setting at item 15 (the name of a compressed FBM to be scanned) in the recognition rule. Then, based on the setting at item 17 (the fail size), a 8×32 bit region is selected from the regions of the compressed FBMs 29A and 29B (step ST24).

Subsequently, the fail rate in the region selected at step ST24 is calculated (step ST25).

In the compressed FBMs 29A and 29B shown in FIGS. 11A and 11B, the number of fail pixels is 4, and the number of pixels that corresponds to the fail size set at item 17 (8×32 bits) is also 4, thereby the fail rate is 100%.

The fail pixel in the region selected at step ST24 is judged based on the condition of the fail rate (100%) set at item 18, and the condition that no adjacent inferior recognition objects are present, set at item 19 (whether or not an inferior recognition object is adjacent). When both judgement conditions are satisfied, the fail pixel in the above region is recognized (estimated) as an inferior recognition object, and it goes to the next step ST27. If not satisfied, it goes to step ST29 (step ST26).

Hereat, the fail rates of the compressed FBM 29A and 29B of FIGS. 11A and 112B are both 100%, which satisfies the fail rate set at item 18, and the condition that no adjacent inferior recognition objects are present, is set at item 19. However, since no fail pixels FPLs are adjacent to each other in the exterior of a region defined by 8×32 bits that corresponds to the fail pixel region, it goes to step ST27.

At step ST27, even for other compressed FBMs which are compressed by other than the compression threshold of FBM-A, the fail rate in the region selected at step ST24 is calculated and normalized by the fail rate obtained at step ST25.

In the compressed FBM 30A shown in FIG. 12A, the number of fail pixels is 4, and the number of pixels that corresponds to the fail size set at item 17 (8×32 bits) is also 4, thereby the fail rate is 100%. Normalization with the fail rate (100%) of the compressed FBM 29A obtained at step ST25, results in 1.

In the compressed FBM 30B shown in FIG. 12B, since the number of fail pixels is zero, the fail rate is 0%. Normalization with the fail rate (100%) of the compressed FBM 29B, results in zero.

Subsequently, based on item 21 (the fail shape judgement rule based on the fail rate of other compressed FBMs which are compressed by other than the compression threshold of FBM-A) in the recognition rule, the fails thus far recognized are rerecognized (specified), or distinguished (step ST28).

Specifically, as to the original FBM 28A shown in FIG. 10A, when compressed with the compression threshold of FBM-B, the normalized fail rate is 1. Therefore, based on the judgement rule using the normalized fail rate of FBM-B, at item 21, the original FBM 28A is rerecognized (specified), or distinguished as “inferior line (NORMAL).”

As to the original FBM 28B shown in FIG. 10B, when compressed with the compression threshold of FBM-B, the normalized fail rate is zero. Therefore, it is judged “not recognize (NOT RECOGNIZE)”

The operations of the following steps ST29 to ST33 are the same as the operations of steps ST9 to ST13 in the first preferred embodiment (see FIG. 2), and therefore its description is omitted.

B-3. Resulting Effects

According to the failure analysis method of the second preferred embodiment as described, a plurality of compressed FBMs having different compression thresholds are prepared as compression conditions, and fail shapes are judged based on their respective fail rates. This permits recognition taking the density of failure into consideration, and also enables to reduce incorrect recognition of fail shapes and increase the classifying accuracy of fail shapes, as compared to the case that fail shapes are judged only by the fail rate of the compressed FBM prepared under a single compression condition.

C. Third Preferred Embodiment

The forgoing failure analysis methods for distinguishing fail shapes are carried out by using a plurality of compressed FBMs. These FBMs are prepared by changing the compression area size in the first preferred embodiment, whereas they are formed by changing the compression threshold with the same compression area in the second preferred embodiment. On the other hand, a third preferred embodiment is directed to a failure analysis method in the case that the compression area size and compression threshold are both changeable.

FIG. 13 is a flow chart illustrating the failure analysis method according to the third preferred embodiment. FIG. 14 is a diagram illustrating one example of fail shape recognition rules for executing the failure analysis method of this embodiment.

C-1. Recognition Rule

An inferior shape recognition rule will be described by referring to FIG. 14.

This rule comprises the same settings as in the recognition rule in the first preferred embodiment described by referring to FIG. 3, except that item 13 in FIG. 3 is replaced with item 31 at which various combinations of a compression area and compression threshold are set.

Specifically, this embodiment employs various combinations of a compression area and compression threshold, as compression conditions. There are set the following four combinations: FBM-A (a compression area of 8×8 bits, and compression threshold of 1 bit), FBM-B (a compression area of 1×32 bits, and compression threshold of 1 bit), FBM-C (a compression area of 32×1 bits, and compression threshold of 1 bit), and FBM-C (a compression area of 8×8 bits, and compression threshold of 8 bits).

Item 21 is an item for setting the fail shape judgement rule based on the normalized fail rates about other compressed FBMs which are compressed by other than a compressed FBM to be scanned, i.e., the compression area and compression threshold of FBM-A. “Inferior block (NORMAL)” is to be judged by the fail rates normalized when compressed with the respective compression areas and compression thresholds of FBM-B to FBM-D.

When any of the normalized fail rates thus obtained is in the range of 0.75 to 1.25, it is judged “inferior block.”

It is so judged as not to make no failure recognition, depending on the fail rate normalized by using the compression threshold of FBM-D.

When this normalized fail rate is in the range of 0 to 0.5, it is so judged as not to recognize any inferior.

Recognition rule for determining either “inferior line (X-line) aligned in x-direction, or “inferior line (Y-line) aligned in y-direction,” is the same as that in the first preferred embodiment.

The setting contents of other items 14 to 20 are the same as in the first preferred embodiment.

C-2. Analysis Operation

The failure analysis operations of steps ST41 to ST53 in the flow chart of FIG. 13, are the same as in steps ST1 to ST13 in the flow chart of FIG. 2, except that at step ST42, the original FBMs are compressed based on the numerical values of various combinations of a compression area and compression threshold, set at item 31 (compression area), and that the fail shape judgment rule used for the inferior rerecognition at step ST48 is complicated by adding the compression threshold of FBM-D.

Referring to the fail shape recognition rule shown in FIG. 14, the compression area of FBM-D is set to 8×8 bits, and its compression threshold is set to 8 bits. This is one example of various combinations of a compression area and compression threshold, and aims to indicate that the number of distinguishable fail shape types can be increased by employing different compression conditions from that of FBM-A to FBM-C. For instance, such a fail shape that is undistinguishable under the compression conditions of FBM-A to FBM-C, can be distinguished by employing one which supplements the above conditions.

C-3. Resulting Effects

According to the failure analysis method of the third preferred embodiment as described, a plurality of compressed FBMs having different compression areas and different compression thresholds are prepared as compression conditions, and fail shapes are judged based on their respective fail rates. This enables to distinguish more kinds of fail shapes and increase the classifying accuracy of fail shapes, as compared to the case of employing only a compression area or compression threshold as a compression condition.

D. Fourth Preferred Embodiment

D-1. Operation of Deriving Compression Thresholds

In the second and third preferred embodiments, descriptions have been made of the case that the original FBMs are compressed by using a compression threshold. The compression threshold should be set to a suitable value depending on the inferior pattern shape. Preset compression thresholds are used in these embodiments. In a fourth preferred embodiment a method of automatically obtaining a suitable compression threshold based on the inferior pattern shape, will be described by referring to FIGS. 15A, 15B, 16, 17A, 17B, and 18.

FIGS. 15A and 15B are diagrams illustrating original FBMs which are prepared by mapping the data about the positions of the fail memory cells detected by the LSI tester 1 shown in FIG. 1, into a region that is divided by x×y=32 bits×32 bits. Specifically, FIGS. 15A and 15B show two different inferior patterns as FBMs 32A and 32B, respectively.

The original FBM 32A shown in FIG. 15A is in such a pattern that a fail bit line FBL composed of a series of fail bits aligned in y-direction is present in the vicinity of the left end as viewed in FIG. 15A.

The original FBM 32B shown in FIG. 15B is in such a pattern that only the left side as viewed in the figure is dotted with fail bits FB.

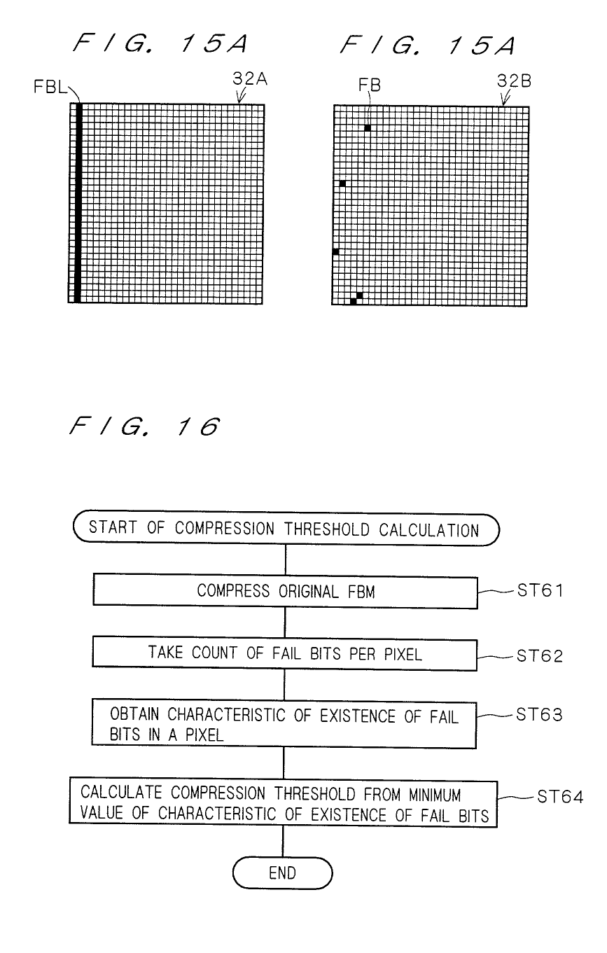

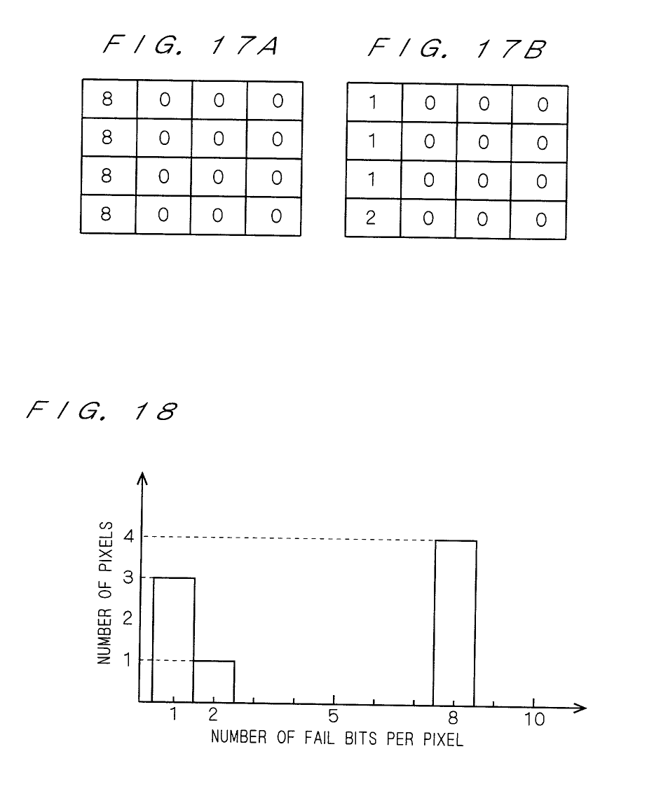

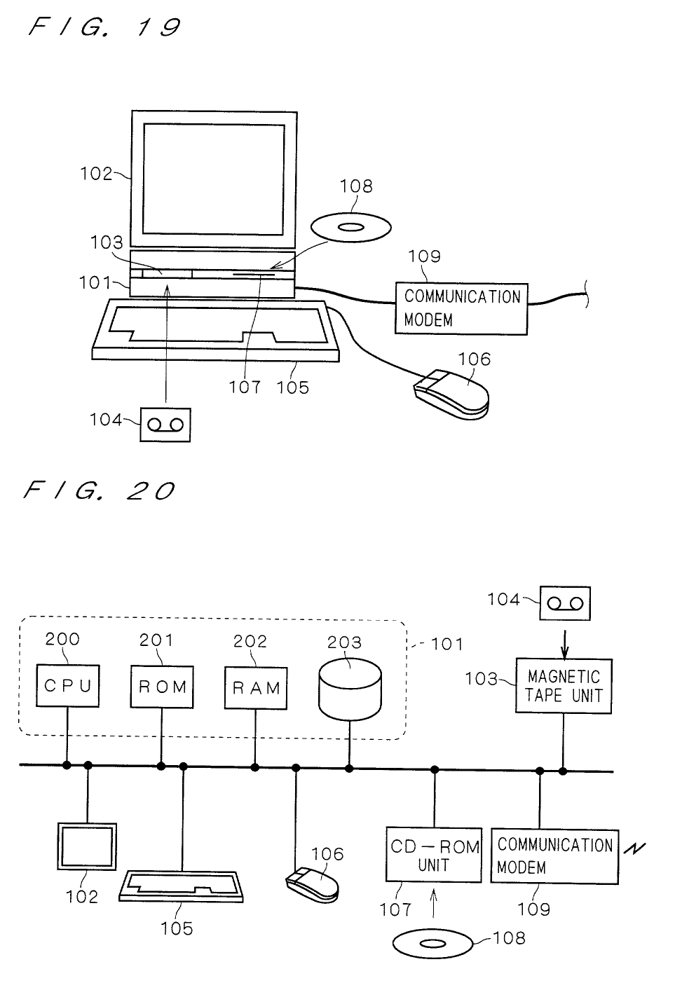

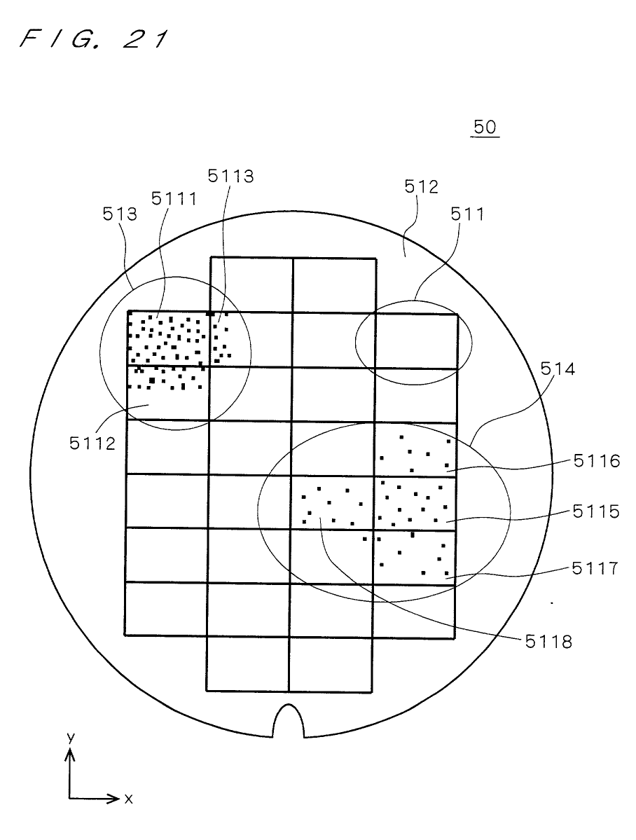

Description will now be made of a method of automatically obtaining compression thresholds based on the data of these original FBMs 32A and 32B, according to the flow chart shown in FIG. 16.

At step ST61, the original FBMs 32A and 32B are compressed based on a predetermined compression area, and its value is, for example, 8×8 bits, which is set at item 26 (compression area) in the recognition rule of the second preferred embodiment as described by referring to FIG. 9.

When the original FBMs 32A and 32B shown in FIGS. 15A and 15B are compressed into the area of 8×8 bits (64 bits), both are divided into a 4×4 pixel matrix.

Subsequently, the number of fail bits per pixel (compression area) is calculated (step ST62). Tables of the number of fail bits per pixel are given in FIGS. 17A and 17B, respectively.

In FIG. 17A, eight fail bits are respectively contained in four pixels of the leftmost column as viewed in the figure, but no fail bits are contained in other pixels.

In FIG. 17B, one fail bit is respectively contained in the first to third pixels from above, and two fail bits are contained in the lowermost pixel, in the leftmost column as viewed in the figure, and no fail bits are contained in other pixels.

Subsequently, based on the number of fail bits per pixel, calculated at step ST62, the characteristic of existence of the fail bits per pixel is obtained (step ST63).

The concept of this operation can be explained graphically by using the number of fail bits per pixel to enter its horizontal axis, and the number of pixels to enter its vertical axis, as shown in FIG. 18.

Referring to FIG. 18, the number of pixels that contain one fail bit is 3, the number of pixels that contain two fail bits is 1, and the number of pixels that contain eight fail bits is 4. This shows that the first abundant is the pixels containing eight fail bits, and the second abundant is the pixels containing one fail bit.

From this graph, assuming that the characteristic of existence of fail bits is approximated by quadratic curve in which the minimum number of pixels is set at zero, compression thresholds are calculated from the minimum value of the characteristic of existence of fail bits (step ST64).

Specifically, the count of pixels is started when the number of fail bits is 1, and the number of fail bits (the value on the horizontal axis) when the number of pixels first reaches zero, i.e., the minimum value, is derived automatically as a compression threshold. Note that the compression threshold thus obtained is 3 bits in this embodiment.

The operation of deriving compression thresholds as described above may be executed, for example, in making the recognition rule shown in FIG. 9. The calculated compression threshold can be used as the compression threshold of FBM-B, in setting compression thresholds at item 27.

D-2. Resulting Effects

Thus, a threshold value capable of ignoring any inferior bits occurred at random, can be obtained by calculating compression thresholds from the characteristic of existence of fail bits contained in a pixel.

In the event of “inferior block” or “inferior line,” the probability that a plurality of fail bits are present in one pixel will increase. In the event of inferior bit occurred at random, the above-mentioned probability will decrease. Therefore, with the method of this preferred embodiment having a high possibility that compression thresholds will be greater than 1, no recognition is made for inferior bits occurred at random, and it is thus possible to obtain automatically compression thresholds suitable for the failure analysis method for recognizing only “inferior block” and “inferior line.”

E. Embodiments of Failure Analysis Method

For the foregoing failure analysis methods of the present invention to be realized, for example, a computer system as shown in FIG. 19 may be utilized.

The EWS for data analysis 2 shown in FIG. 1 is configured by the computer system shown in FIG. 19.

In FIG. 19, the EWS for data analysis 2 comprises a computer body 101, display unit 102, magnetic tape unit 103 into which a magnetic tape 104 is fit, key board 105, mouse 106, CD-ROM unit 107 into which a CD-ROM (Compact DISC-READ ONLY MEMORY) 108 is fit, and communication modem 109. Needless to say, it may be so constructed as to use a recording medium other than magnetic tapes or CD-ROMs.

The failure analysis methods according to the present invention as described by referring to FIGS. 2, 8 or 13, can be realized by executing a computer program on computer. In this case, the program is supplied by a recording medium such as the magnetic tape 104 or CD-ROM 108. Also, the program can be propagated in the form of signals on a communication channel, and then downloaded to a recording medium.

A program that realizes the failure analysis method of the invention (hereinafter referred to as “failure analysis program”) is executed on the computer body 101, and the operator performs the failure analysis by operating the keyboard 105 or mouse 106, while watching the display unit 102. The failure analysis program may be supplied via the communication modem 109 to the computer body 101, from other computer via a communication line.

FIG. 20 is a block diagram illustrating the configuration of the computer system shown in FIG. 19. The computer body 101 shown in FIG. 19 has a CPU (CENTRAL PROCESSING UNIT) 200, ROM (READ ONLY MEMORY) 201, RAM (RANDOM ACCESS MEMORY) 202, and a hard disk 203.

The CPU 200 performs processing by inputting/outputting data among the display unit 102, magnetic tape unit 103, keyboard 105, mouse 106, CD-ROM unit 107, communication modem 109, ROM 201, RAM 202, and hard disk 203.

By the CPU 200, the failure analysis program recorded in a recording medium, such as the magnetic tape 104 or CD-ROM 108, is stored temporally in the hard disk 203. By the CPU 200, the failure analysis program is loaded from the hard disk 203 to the RAM 202, and executed the program for performing the failure analysis.

It should be understood that the foregoing computer system is described by way of example, and one could use any other means which can execute the failure analysis program.

In addition, by the above-mentioned computer system, it is, of course, able to realize the program for deriving compression thresholds which is described as the fourth preferred embodiment by referring to the flow chart of FIG. 16.

F. Fifth Preferred Embodiment

F-1. Example of Failure Groups Classified

FIG. 21 shows an original FBM 50 including failure groups classified by applying a fifth embodiment of the failure analysis method according to the invention.

The original FBM 50 is an original FBM of a semiconductor wafer 512 in which 28 semiconductor devices 511 each having the number of memory cells (x×y) of 32 bits×16 bits (=total 512 bits) are formed. In the following description, the semiconductor devices 511 may be described by being designated by reference numerals 5111 to 5113 and 5115 to 5118 so as to be discriminated from each other for convenience.

In FIG. 21, fail memory cells, that is, fail bits FB are blackened. Fail bits exist in an upper left area 513 and an area 514 on the right side in the drawing.

The density of fail bits (hereinbelow, called failure density) in the area 513 is high, and that in the area 514 is low.

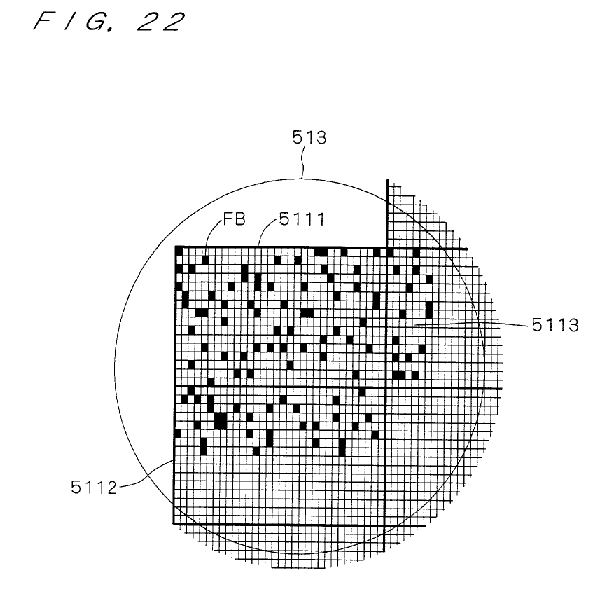

FIG. 22 shows the details of the area 513. As shown in FIG. 22, the fail bits FB occur in the entire area of a semiconductor device 5111 at the left corner and around borders in semiconductor devices 5112 and 5113 adjacent to the semiconductor device 5111.

F-2. Analyzing Operation

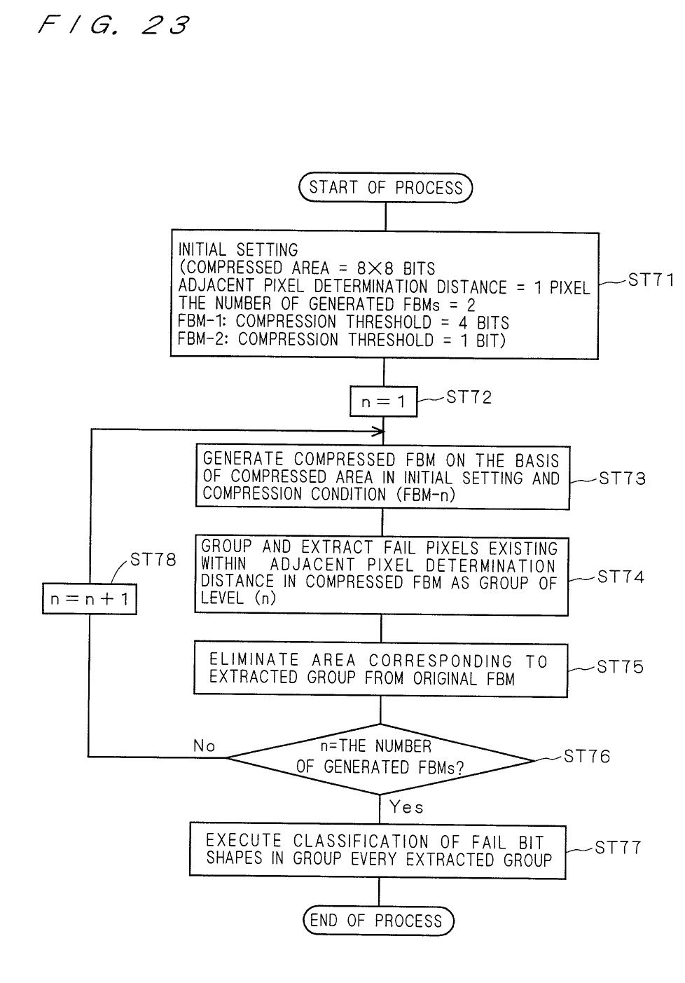

By using the flow chart shown in FIG. 23, with reference to FIGS. 21, 22, and 24 to 27, a failure analyzing operation of the fifth embodiment will now be described.

First, at step ST71, initial setting is read. As initial setting, it is assumed that the size of a compressed area is 8×8 bits, adjacent pixel determining distance is one pixel, the number of FBMs to be generated is two, a compression threshold of a compressing condition FBM-1 for specifying one of the FBMs is four bits, and a compression threshold of a compressing condition FBM-2 for specifying the other FBM-2 is one bit.

The adjacent pixel determining distance is a parameter for defining that a fail pixel existing within a predetermined distance (which is specified by the number of pixel cells) from a specific fail pixel belongs to the same group. In this case, it is assumed that fail pixels existing in one pixel belong to the same group.

Any fail pixel can be used as the specific fail pixel. First, any fail pixel is selected, whether or not there is a fail pixel within a adjacent pixel determining distance around the selected fail pixel as a center is examined, and a adjacent pixel determining process is repeated by using any of the examined fail pixels as a center, thereby grouping fail pixels.

At step ST72, “1” is set as a variable (n). The variable (n) is a numerical value incremented each time a series of processes of steps ST73 to ST75 are repeated. The variable (n) is incremented until it reaches the number of FBMs to be generated, which is set at step ST71.

By setting the variable (n) to “1”, compression based on the compression condition FBM-1 is performed. At step ST73, the original FBM 50 shown in FIG. 21 is divided into compressed areas (each consisting of 8×8 bits) set at step ST71, and compression is performed on the basis of the set compression threshold (four bits) in the compression condition FBM-1, thereby generating a compressed FBM 51.

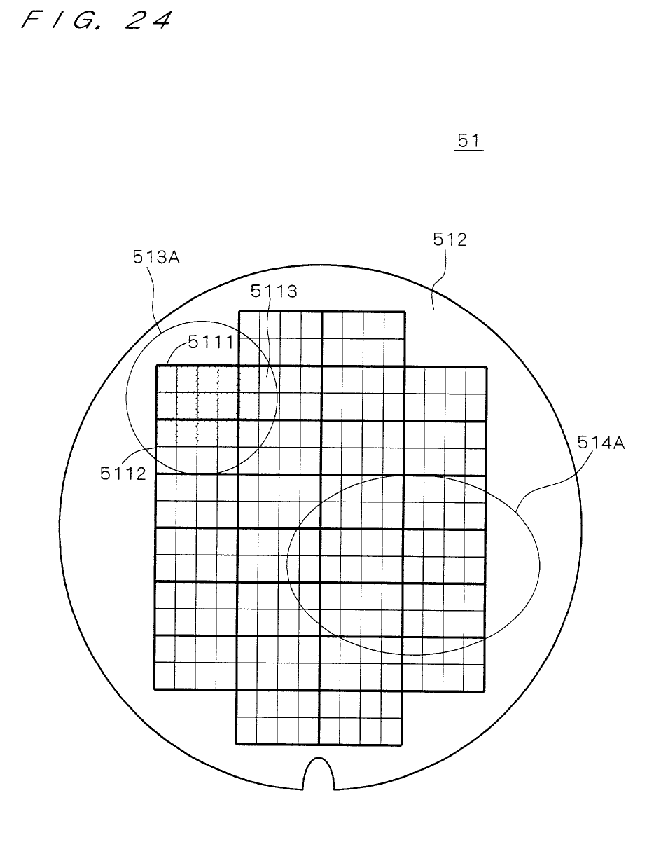

FIG. 24 shows the compressed FBM 51. When the original FBM 50 shown in FIGS. 21 and 22 is compressed into areas each consisting of 8 bits in the x-direction and 8 bits in the y-direction and failure detection is performed every four bits of the compression threshold, although fail pixels (which are hatched) exist densely in an area 513A, no fail pixel exists in an area 514A. The areas 513A and 514A are areas on the compressed FBM corresponding to the areas 513 and 514 in FIG. 21.

It denotes that less than four bits exist in each of all the pixels in the area 514A, and all the pixels are determined as pass pixels.

Referring again to FIG. 23, at step ST74, by grouping and extracting adjacent fail pixels existing within the adjacent fail pixel determining distance (one pixel) in the compressed FBM 51 as a group of level 1. In this case, all of fail pixels in the area 513A are extracted as the group of level 1.

The level 1 denotes the result of performing the process by using the variable (n) of 1 set at step ST72.

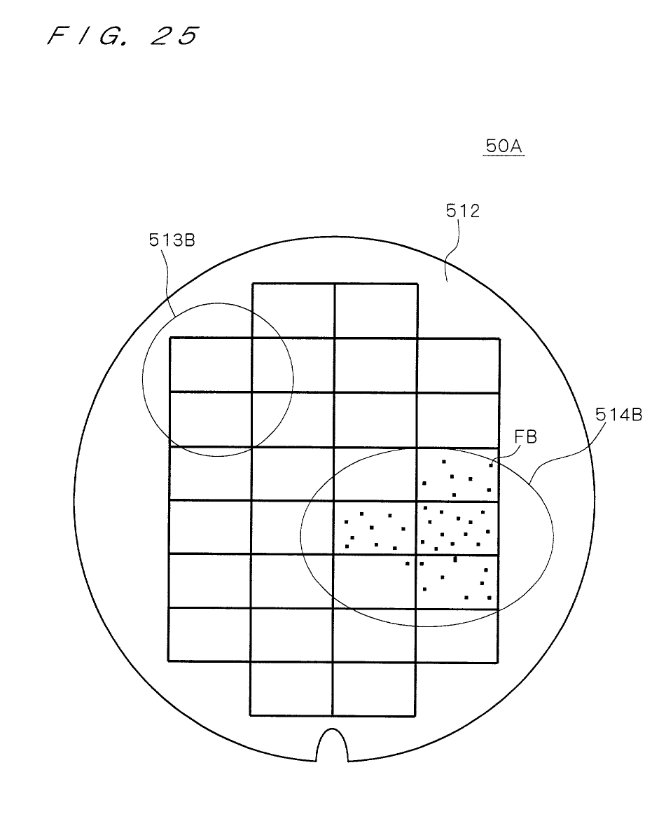

The fail bits in the group extracted at step ST74 are eliminated from the original FBM (step ST75). In this case, the fail bits in the area 513 are eliminated from the original FBM 50 and a processed original FBM 50A shown in FIG. 25 is obtained.

In FIG. 25, the fail bits are eliminated from the area 513B and the fail bits FB exist only in the area 514B. The areas 513B and 514B are the areas in the processed original FBM corresponding to the areas 513 and 514 in FIG. 21.

After the series of grouping processes at steps ST73 to ST75 are finished, whether the variable (n) has reached “2” as the number of FBMs generated or not is checked at step ST76.

Since the number of FBMs generated does not reach “2”, “1” is added to the variable (n) at step ST78, and process at step ST73 and subsequent steps are repeated.

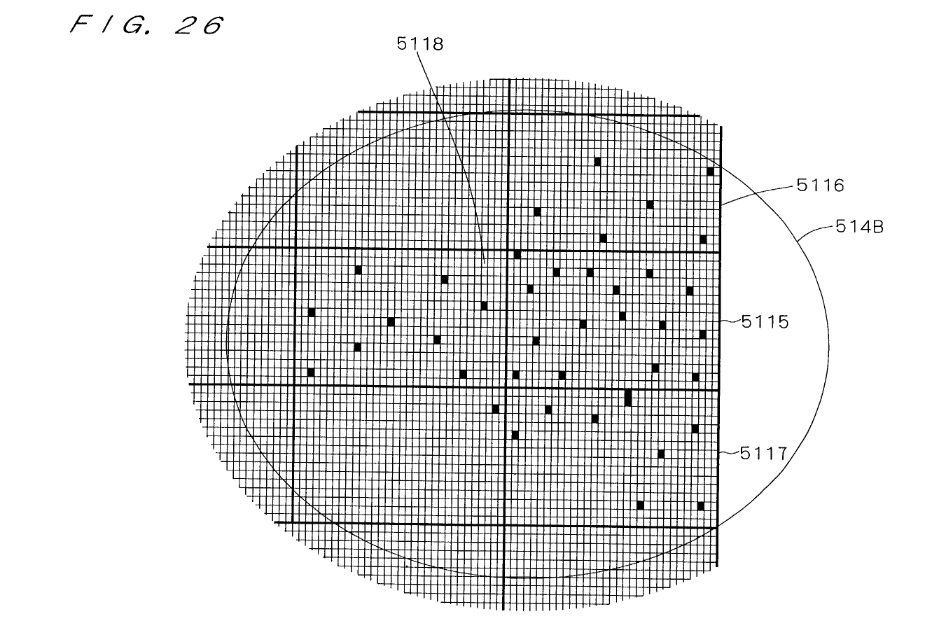

FIG. 26 shows the details of the area 514B in FIG. 25. As shown in FIG. 26, the fail bits FB occur sparsely in a semiconductor device 5115 and semiconductor devices 5116, 5117, and 5118 adjacent to the semiconductor device 5115.

By setting the variable (n) to 2, compression based on the compression condition FBM-2 is performed. At step ST73, the processed original FBM 50A shown in FIG. 25 is divided into the compression areas (each consisting of 8×8 bits) set at step ST71, compression is made on the basis of the set compression threshold (one bit) of the compression condition FBM-2, thereby generating a compressed FBM 52.

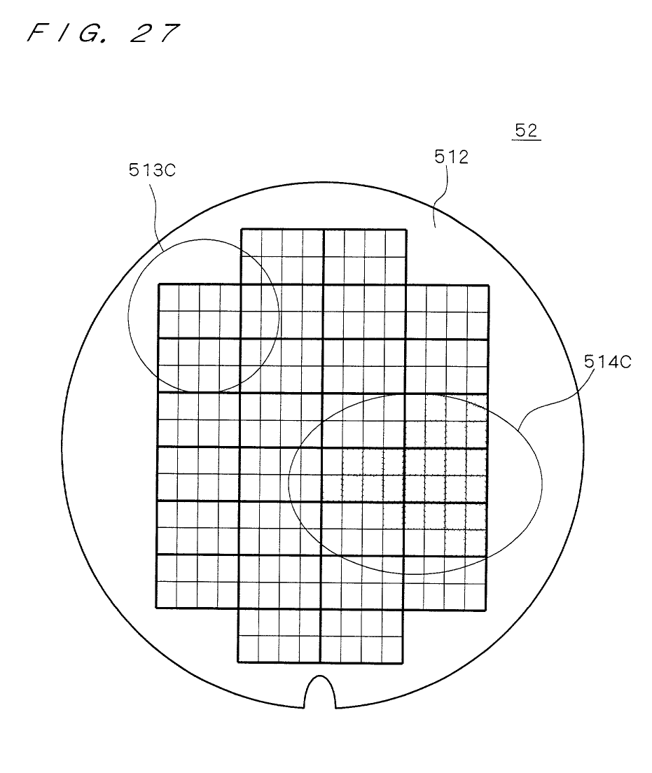

FIG. 27 shows the compressed FBM 52. When the processed original FBM 50A shown in FIG. 25 is compressed to the areas each consisting of 8 bits in the x-direction and 8 bits in the y-direction, and failure detection is performed every bit of the compression threshold, fail pixels (which are hatched) exist densely in an area 514C. Since the fail bits have been eliminated in the area 513C in the processed original FBM 50A, no fail pixel exists. The areas 513C and 514C are areas on the compressed FBM corresponding to the areas 513 and 514 in FIG. 21.

Referring again to FIG. 23, at step ST74, adjacent fail pixels existing within the adjacent fail pixel determining distance (one pixel) in the compressed FBM 52 are grouped and extracted as a group of level 2. In this case, all of fail pixels in the area 514C are extracted as the group of level 2.

The level 2 denotes the result of performing the process by using the variable of 2 set, at step ST72.

The fail bits in the group extracted at step ST74 are eliminated from the original FBM (step ST75). In this case, the fail bits in the area 514C are eliminated from the processed original FBM 50A, so that there is no fail bit on the FBM.

After the series of grouping processes at steps ST73 to ST75 are finished, whether the variable (n) reaches “2” as the number of FBMs generated or not is checked at step ST76.

Since the variable (n) is 2 and reaches 2 as the number of FBMs generated, the program advances to step ST77. At step ST77, fail bit shapes in each of the groups extracted are classified.

For the classification of the fail bit shapes in each group, the failure analysis method described in the first to fourth embodiments may be used. Alternately, other general failure analysis methods can be also used.

F-3. Action an Effect

In the failure analysis method of the fifth embodiment as described above, a plurality of compressed FBMs are generated while changing the compression threshold and pixels existing in a predetermined adjacent fail pixel determination distance are dealt as pixels belonging to the same group, thereby enabling areas having different fail pixel densities to be grouped as different groups. After the areas are grouped, the fail bit shapes are classified on the group unit basis, so that the cause of the failure can be effectively specified.

That is, when failures occur densely, local concentrated occurrence of foreign matters are considered as a cause. Since the cause varies according to the failure density, the areas of different failure densities are grouped as different groups, and the fail bit shapes are classified, thereby enabling the cause of failure to be specified more accurately.

G. Sixth Preferred Embodiment

G-1. Example of Failure Groups to be Classified

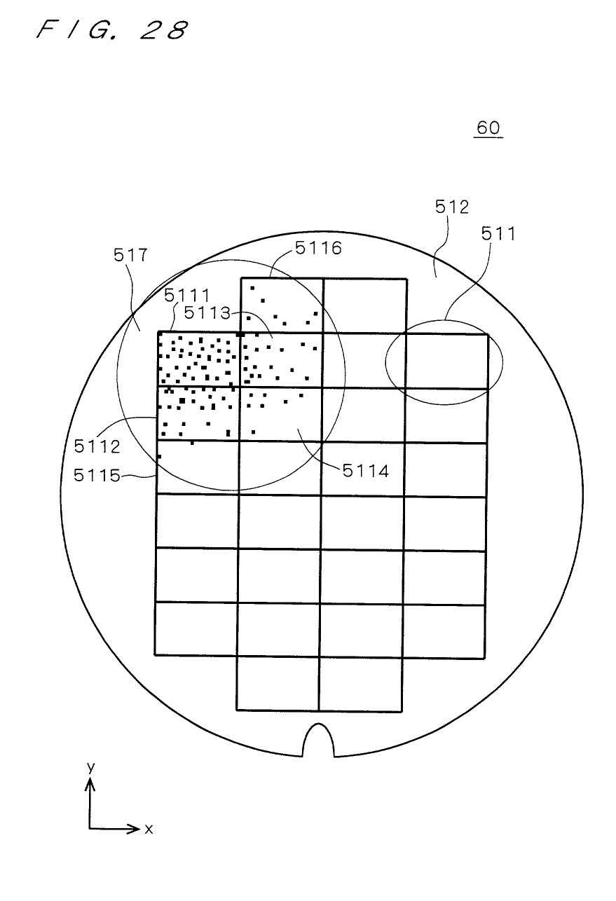

FIG. 28 shows an original FBM 60 including failure groups classified by applying a sixth embodiment of a failure analysis method according to the invention.

The basic configuration of the original FBM 60 is the same as that of the original FBM 50 shown in FIG. 21. The same configurations are designated by the same reference numerals and repeated description will be omitted here.

In the following description, the semiconductor devices 511 may be described by being designated by reference numerals 5111 to 5116 so as to be discriminated from each other for convenience.

In FIG. 28, fail memory cells, that is, fail bits FB are blackened. Fail bits exist in an upper left area 517 in the drawing. The area 517 has a distribution in fail bit density.

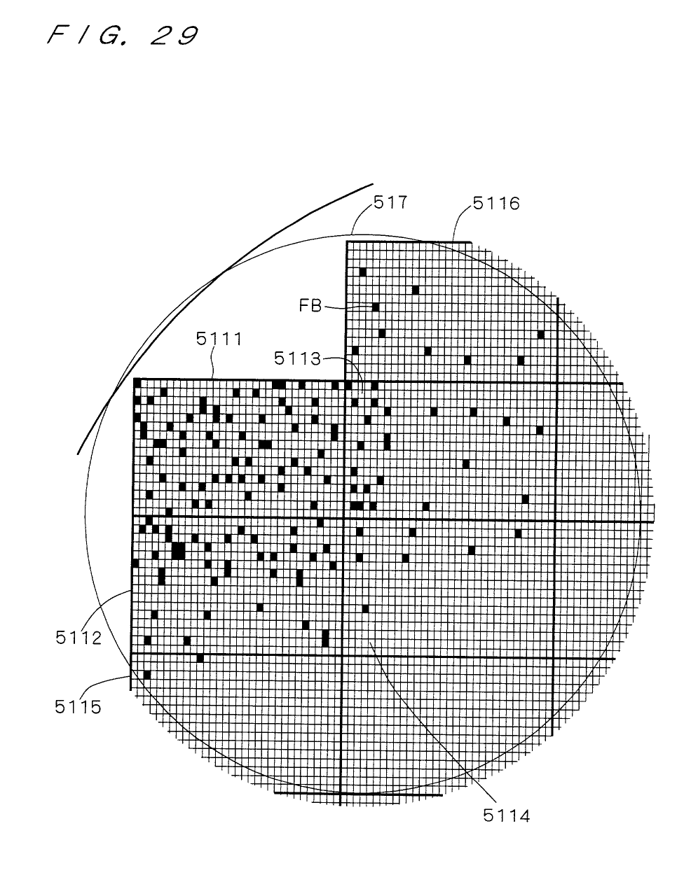

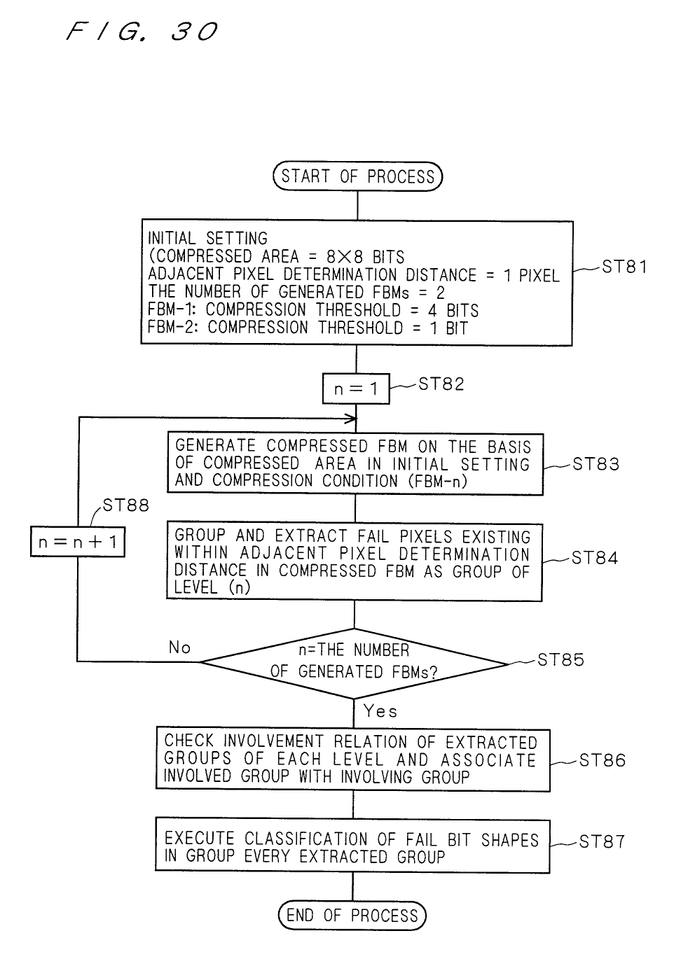

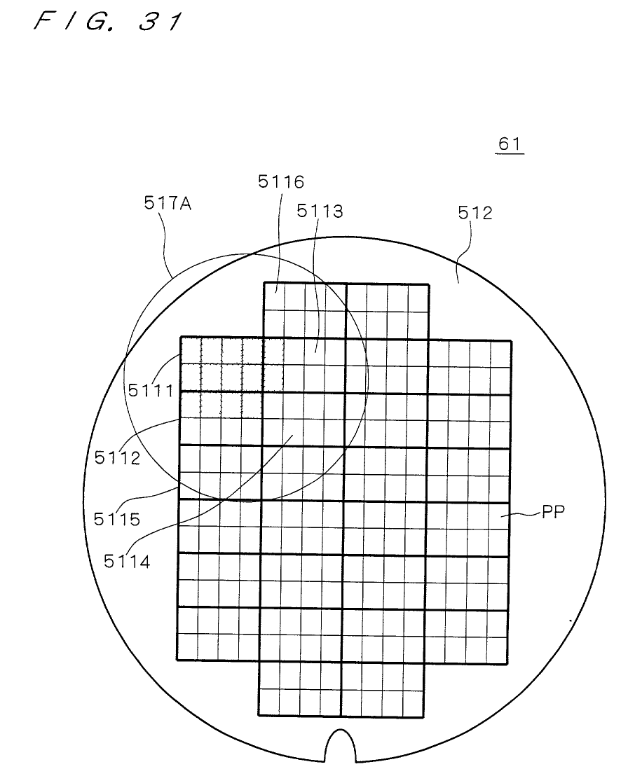

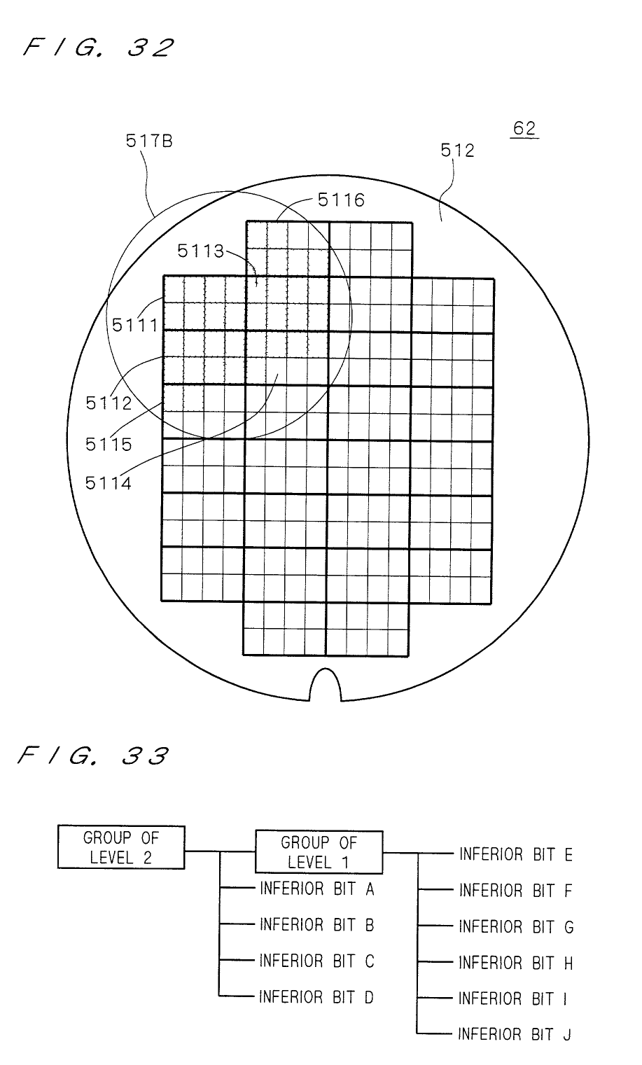

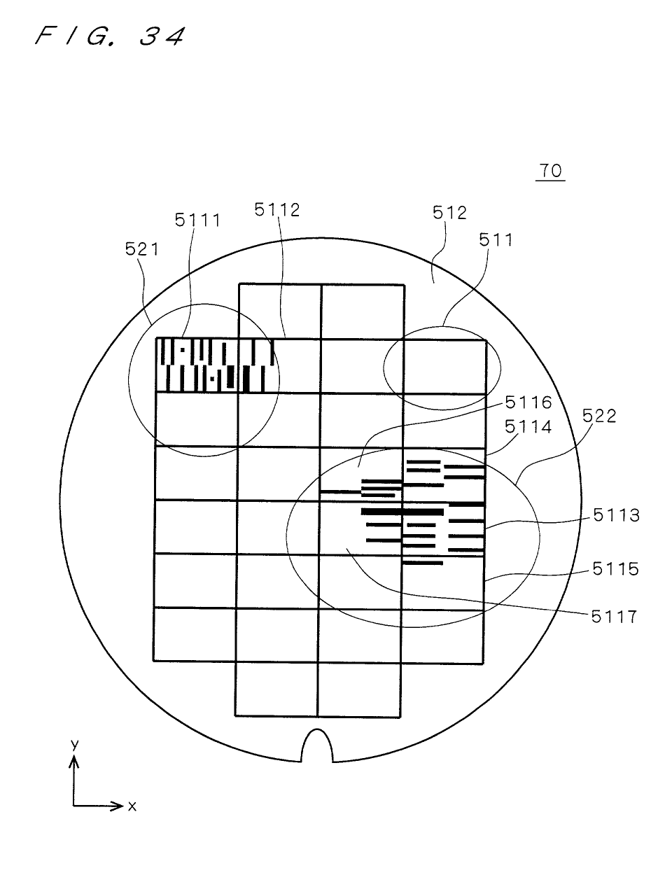

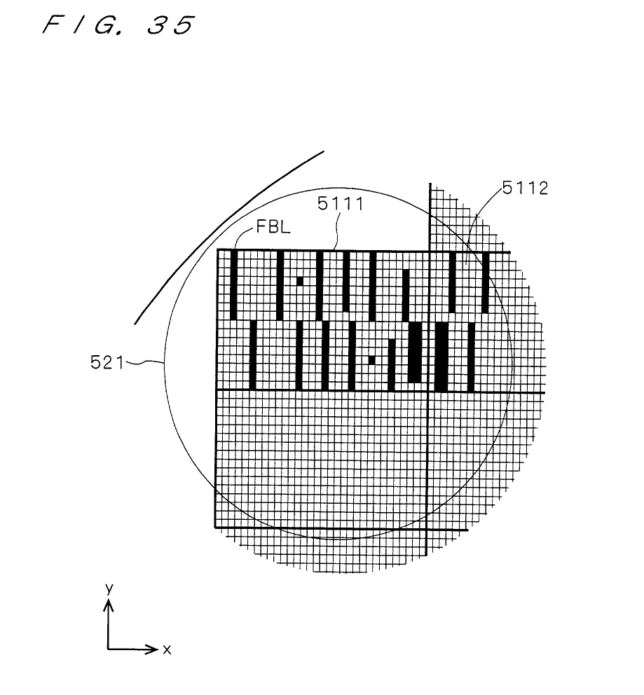

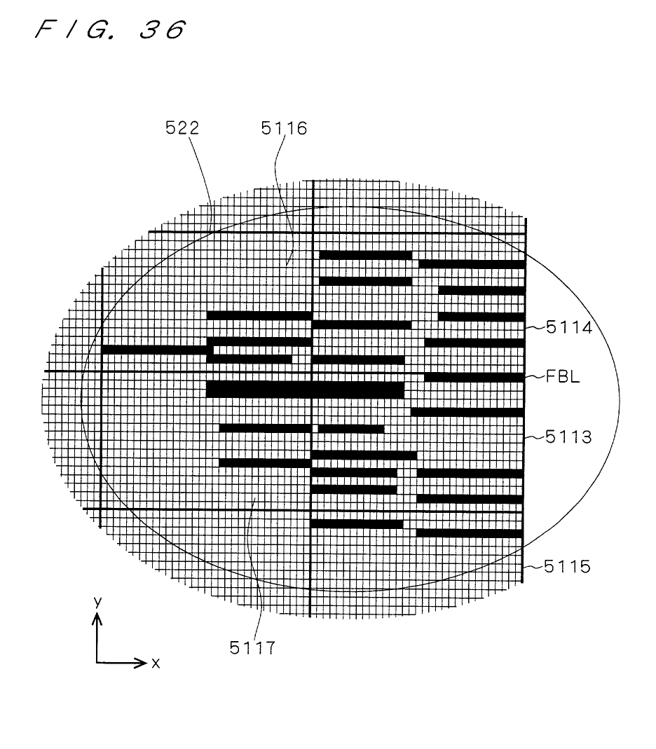

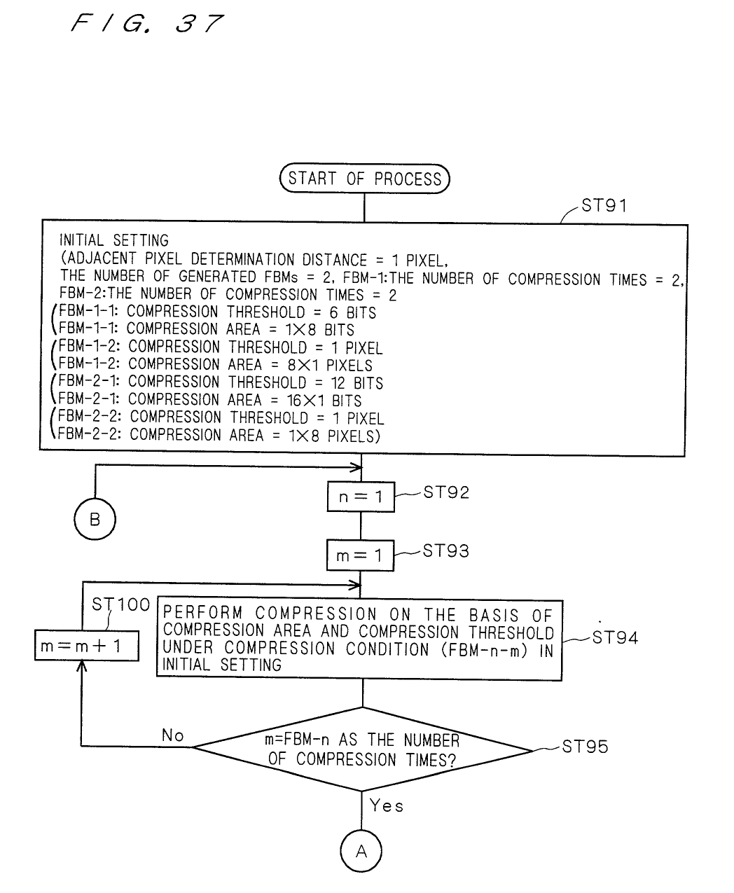

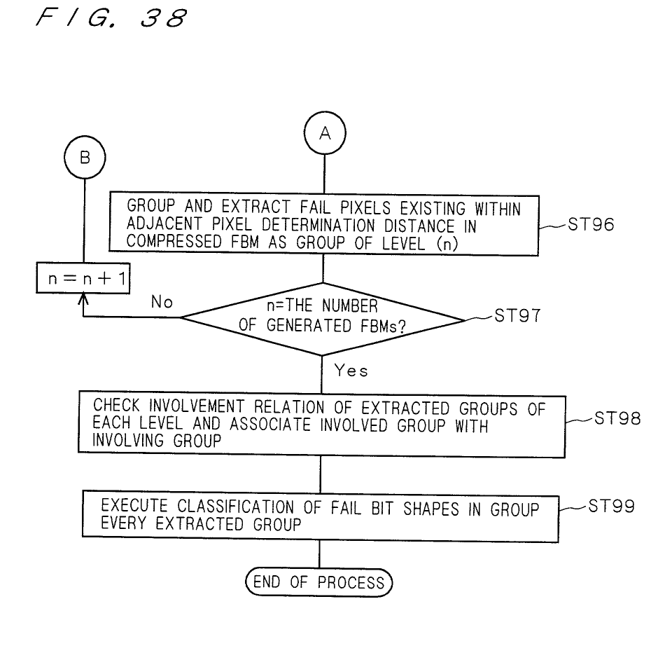

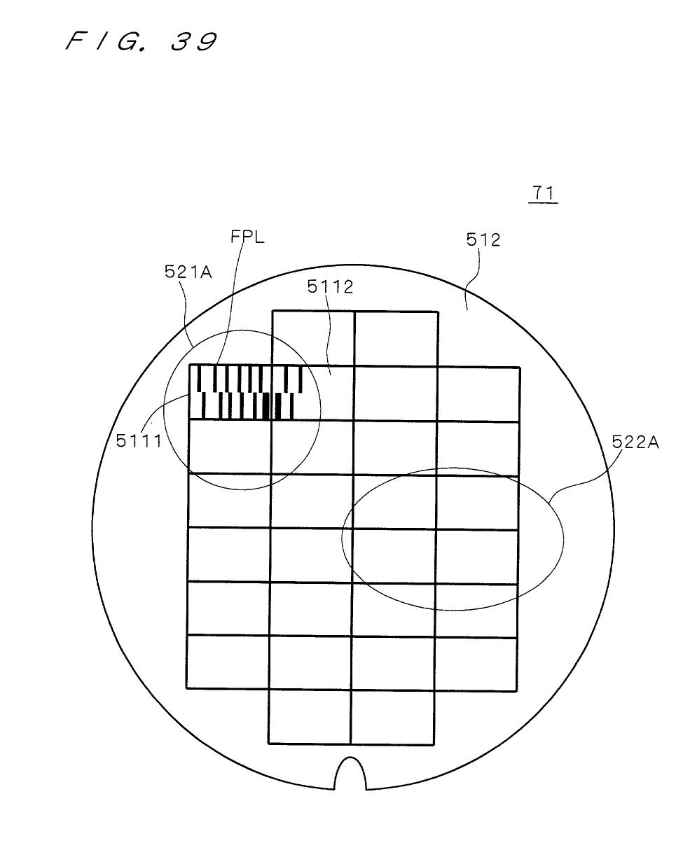

FIG. 29 specifically shows the area 517. As shown in FIG. 29, the fail bits FB occur in the semiconductor device 5111 at the left corner and in the semiconductor devices 5112 to 5116 adjacent to the semiconductor device 5111. The fail bit density is relatively high in the semiconductor device 5111 and around the borders of the semiconductor devices 5112 and 5113 adjacent to the semiconductor device 5111. The fail bit density decreases with distance from the semiconductor device 5111.

G-2. Analyzing Operation

By using the flow chart shown in FIG. 30, with reference to FIGS. 28, 29, and 31 to 33, a failure analyzing operation of the sixth embodiment will now be described.

Processes at steps ST81 to ST84 are the same as those at steps ST71 to ST74 described by using FIG. 23, and the repeated description will be omitted here.

After steps ST81 and ST82, at step ST83, the original FBM 60 shown in FIG. 29 is divided into compressed areas (each consisting of 8×8 bits) set at step ST81, and compression is performed on the basis of the set compression threshold (four bits) in the compression condition FBM-1, thereby generating a compressed FBM 61.

FIG. 31 shows the compressed FBM 61. When the original FBM 60 shown in FIGS. 28 and 29 is compressed into areas each consisting of 8 bits in the x-direction and 8 bits in the y-direction and failure detection is performed every four bits of the compression threshold, although fail pixels (which are hatched) exist densely in the semiconductor device 5111 and around the borders in the semiconductor devices 5112 and 5113 adjacent to the semiconductor device 5111, no fail pixel exists in the other semiconductor devices 5112 to 5116. The area 517A is an area on the compressed FBM corresponding to the area 517 in FIG. 28.

Each of the hatched portions in the area 517A denotes an area having a relatively high failure density in which fail bits of four or more bits exist per pixel. In the other areas, fail bits less than four bits per pixel exist, and the failure density is low.

Referring again to FIG. 30, at step ST84, adjacent fail pixels existing within the adjacent fail pixel determining distance (one pixel) in the compressed FBM 61 are grouped and extracted as a group of level 1. In this case, all of fail pixels in the area 517A are extracted as the group of level 1.

After the series of grouping processes at steps ST83 and ST84 are finished, at step ST85, whether the variable (n) reaches “2” as the number of FBMs generated or not is checked.

Since the number of FBMs generated does not reach “2”, “1” is added to the variable (n) at step ST88, and processes at step ST83 and subsequent steps are repeated.

By setting the variable (n) to 2, compression based on the compression condition FBM-2 is performed. At step ST83, the processed original FBM 60 shown in FIGS. 28 and 29 is divided into the compressed areas (each consisting of 8×8 bits) set at step ST81, and compression is made on the basis of the set compression threshold (one bit) of the compression condition FBM-2, thereby generating a compressed FBM 62.

FIG. 32 shows the compressed FBM 62. When the processed original FBM 60 shown in FIGS. 28 and 29 is divided into the areas each consisting of 8 bits in the x-direction and 8 bits in the y-direction, and failure detection is performed every bit of the compression threshold, fail pixels (which are hatched) exist densely in the semiconductor device 5111 and the semiconductor devices 5112 to 5116 adjacent to the semiconductor device 5111. The area 517B is an area on the compressed FBM corresponding to the area 517 in FIG. 28.

Referring again to FIG. 30, at step ST84, adjacent fail pixels existing within the adjacent fail pixel determining distance (one pixel) in the compressed FBM 62 are grouped and extracted as a group of level 2. In this case, all of fail pixels in the area 517B are extracted as the group of level 2.

After the series of grouping processes at steps ST83 and ST84 are finished, at step ST85, whether the variable (n) reaches “2” as the number of FBMs generated or not is checked.

Since the variable (n) is 2 and reaches 2 as the number of FBMs generated, the program advances to step ST86 where the involvement relation is checked every extracted groups of the level, and an involved group is associated with an involving group. In this case, the group of fail pixels of level 1 in the area 517A is involved in the group of fail pixels of level 2 in the area 517B, and the area 517A is associated as a part of the area 517B.

The involvement relation among groups is checked as follows. Formation areas of fail pixels constructing each group on the compressed fail bit map, in this case, x and y coordinates of the group of fail pixels of level 1 hatched in FIG. 31 and those of the group of fail pixels of level 2 hatched in FIG. 32 are compared with each other, thereby specifying the relation between the involving group and the involved group.

For example, when the group of fail pixels of level 1 extends from 0 to 20 in the x coordinate and from 0 to 20 in the y coordinate, and the group of fail pixels of level 2 extends from 0 to 30 in the x coordinate and from 0 to 30 in the y coordinate, it is determined that the group of fail pixels of level 1 is involved in the group of fail pixels of level 2.

By classifying the shapes of fail bits in each of the extracted groups at step ST87, the result of classification of the fail bit shapes as shown in FIG. 33 is obtained.

FIG. 33 shows the result of the classification of the fail bit shapes outputted as a system diagram so as to clarify the involvement relations. The group of level 1 is included in the group of level 2 and, as other failures, inferior bits A to D are also included. It is shown that inferior bits E to J are included in the group of level 1.

Each of the inferior bits A to J is only an example of adopting, for convenience, a part of inferior bits obtained by analyzing the shape of fail bits in the original FBM 60 shown in FIGS. 28 and 29. Obviously, an inferior block and an inferior line can be also adopted by analyzing the shape of fail bits.

For classification of the fail bit shape in each group, the failure analysis methods described in the first to fourth embodiments may be also used or a general failure analysis method can be also used.

G-3. Action and Effect

In the failure analysis method of the sixth embodiment as described above, a plurality of compressed FBMs are generated while changing the compression threshold and pixels existing in a predetermined adjacent fail pixel determination distance are dealt as pixels belonging to the same group, thereby enabling areas having different failure densities to be grouped as different groups. After the areas are grouped, the involvement relation among groups is checked and the fail bit shapes are classified on the group unit basis, thereby enabling the cause of the failure to be effectively specified.

That is, when failures occur densely, for example, concentrated occurrence of local foreign matters is considered as a cause. Since the cause varies according to the failure density, the areas of different failure densities are grouped as different groups, and the fail bit shapes are classified, thereby enabling the cause of failure to be specified more accurately. By checking the involvement relation, the fail bit density distribution can be known, so that an effective source for determining the cause of the failure can be obtained.

H. Seventh Preferred Embodiment

H-1. Example of Failure Groups Classified

FIG. 34 shows an original FBM 70 including failure groups classified by applying a seventh embodiment of a failure analysis method according to the invention.

The basic configuration of the original FBM 70 is the same as that of the original FBM 50 shown in FIG. 21. The same configurations are designated by the same reference numerals and repeated description will be omitted here.

In the following description, the semiconductor devices 511 may be described by being designated by reference numerals 5111 to 5117 so as to be discriminated from each other for convenience.

In FIG. 34, inferior lines (X-Lines) extending in the x-direction exist in an upper left area 521 in the drawing and inferior lines (Y-Lines) extending in the y-direction exist in an area 522 on the right side. The inferior lines are blackened.

FIG. 35 specifically shows the area 521. As shown in FIG. 35, a fail bit line FBL in which fail bits are lined in the y-direction occurs in the entire area of the semiconductor device 5111 at the left corner and around the border in the semiconductor device 5112 adjacent to the semiconductor device 5111.

FIG. 36 specifically shows the area 522. As shown in FIG. 36, a fail bit line FBL in which fail bits are lined in the x-direction occurs in the entire area of the semiconductor device 5113 and in the semiconductor devices 5114 to 5117 around the semiconductor device 5113.

H-2. Analyzing Operation

By using the flow chart shown in FIGS. 37 and 38, with reference to FIGS. 34 to 36 and FIGS. 38 to 44, a failure analyzing operation of the seventh embodiment will now be described. FIGS. 37 and 38 are connected to each other via reference characters A and B.

First, at step ST91, initial setting is read. As initial setting, it is assumed that adjacent pixel determining distance is one pixel, the number of FBMs to be generated is two, the number of compression times of the compressing condition FBM-1 for specifying one of the FBMs is 2, and the number of compression times of the compressing condition FBM-2 is 2.

The number of compression times denotes the number of performing the compressing process on a single FBM. When the number of compression times is 2, the compressing process is performed twice. Since the compression condition for the first compression and that for the second compression are made different from each other, total four kinds of compression conditions are set.

The four kinds of compression conditions are as follows. In the compression condition FBM-1-1, the compression threshold is 6 bits and the size of the compression area is 1×8 bits. In the compression condition FBM-1-2, the compression threshold is one pixel and the size of the compression area is 8×1 pixels. In the compression condition FBM-2-1, the compression threshold is 12 bits and the size of the compression area is 16×1 bits. In the compression condition FBM-2-2, the compression threshold is 1 pixel and the size of the compression area is 1×8 pixels.

The compression conditions FBM-1-1 and FBM-1-2 are compression conditions in which the fail shape of the area 521 is considered. The compression conditions FBM-2-1 and FBM-2-2 are compression conditions in which the fail shape of the area 522 is considered.

1” is set as the variable (n) at step ST92, and “1” is set as the variable (m) at step ST93.

The variable (m) denotes a numerical value incremented one by one each time the process at step ST94 is performed. The variable (m) is incremented up to the number of compression times set at step ST91.

The variable (n) denotes a numerical value incremented one by one each time the processes at steps ST94 to ST96 are performed. The variable (n) is incremented up to the number of generated FBMs set at step ST91.

By setting “1” to each of the variables (n) and (m), the compression under the compression condition FBM-1-1 is performed. At step ST94, the original FBM 70 shown in FIGS. 34 to 36 is divided into compression areas (each consisting of 1×8 bits) under the compression condition FBM-1-1 set at step ST91, and compression is performed on the basis of the set compression value (6 bits), thereby generating the compressed FBM 71.

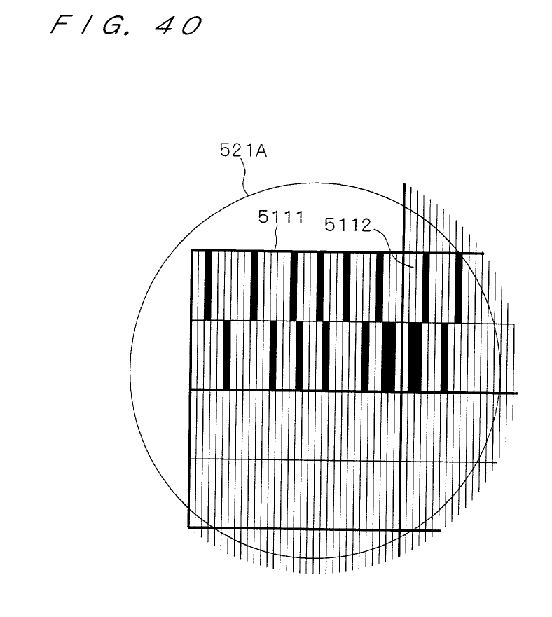

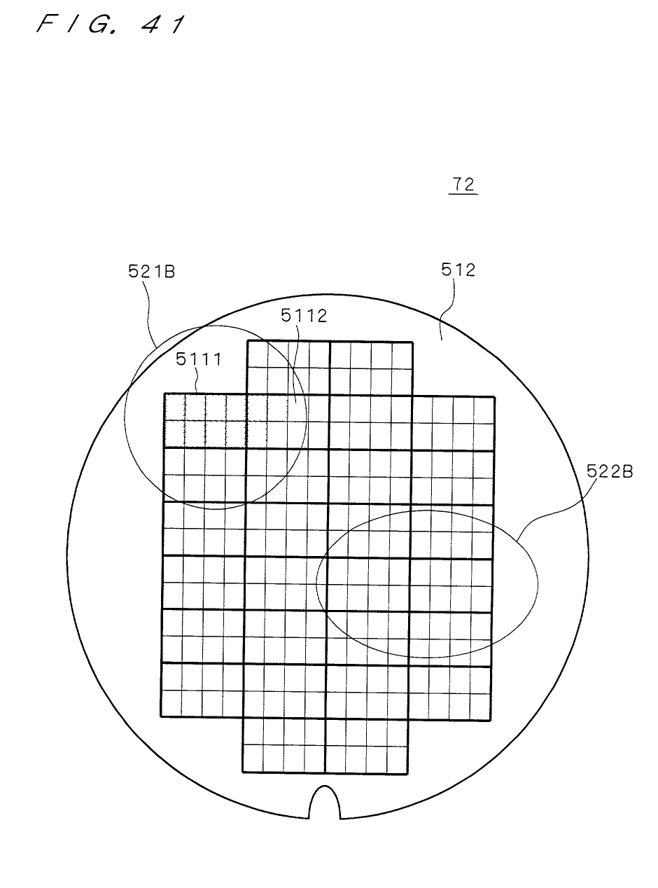

FIGS. 39 and 40 show the compressed FBM 71. When the original FBM 70 shown in FIGS. 34 to 36 is divided into areas each consisting of 1 bit in the x-direction and 8 bits in the y-direction and the failure detection is performed every 6 bits of the compression threshold, although fail pixels (blackened) exist in the area 521A, no fail pixel exists in the area 522A. The areas 521A and 522A are areas on the compressed FBM corresponding to the areas 521 and 522 in FIG. 34.

FIG. 40 shows the details of the area 521B in FIG. 39. A plurality of fail pixels FPL in stripes exist in the entire area of the semiconductor device 5111 and around the border in the semiconductor device 5112 adjacent to the semiconductor device 5111.

Referring again to FIG. 37, at step ST95, whether the variable (m) reaches 2 as the number of compression times of FBM-1 or not is checked.

Since the number of compression times of the FBM-1 does not reach 2 in this case, “1” is added to the variable (m) at step ST100, and the process at step ST94 is repeated.

By setting the variable (m) to 2, compression under the compression condition FBM-1-2 is performed. At step ST94, the compressed FBM 71 shown in FIG. 39 is divided into the compressed areas (each consisting of 8×1 pixels) under the compression condition FBM-1-2 set at step ST91, and compression is further made on the basis of the set compression threshold (one pixel), thereby generating a repeatedly-compressed FBM 72.

FIG. 41 shows the repeatedly-compressed FBM 72. The compressed FBM 71 shown in FIG. 39 is further compressed to areas each consisting of 8 pixels in the x-direction and one pixel in the y-direction, and failure detection is performed every pixel of the compression threshold, in an area 521B, fail pixels (which are hatched) exist densely in the entire area of the semiconductor device 5111 and around the border of the semiconductor device 5112 adjacent to the semiconductor device 5111. Obviously, no fail pixel exists in an area 522B.

The areas 521B and 522B are areas on the compressed FBM corresponding to the areas 521 and 522 in FIG. 34.

Referring again to FIG. 37, at step ST95, whether the variable (m) reaches 2 as the number of compression times of FBM-1 or not is determined.

Since the number of compression times of FBM-1 is 2 in this case, the program advances to step ST96 shown in FIG. 38. At step ST96, adjacent fail pixels existing within the adjacent fail pixel determining distance (one pixel) in the repeatedly compressed FBM 72 are grouped and extracted as a group of level 1 (inferior lines extending in the x-direction).

In this case, all of fail pixels in the area 521B are extracted as the group of level 1.

The level 1 denotes the result of performing the process by using the variable (n) of 1 set at step ST92.

After repeating steps ST94 to ST96 shown in FIGS. 37 and 38 and finishing the series of grouping processes, at step ST97, whether or not the variable (n) has reached “2” as the number of generated FBMs is checked.

Since the number of FBMs generated has not reached 2 yet, “1” is added to the variable (n) at step ST101 and the processes at step ST93 and subsequent steps are repeated.

First, by setting 1 as the variable (m) at step ST93, the variable (n)=2 and the variable (m)=1 are set, and compression under the compression condition FBM-2-1 is performed.

At step ST94, therefore, the original FBM 70 shown in FIG. 34 is divided into compressed areas (each consisting of 16×1 bits) under the compression condition FBM-2-1 set at step ST91, and compression is performed on the basis of the set compression threshold (12 bits), thereby generating a compressed FBM 73.

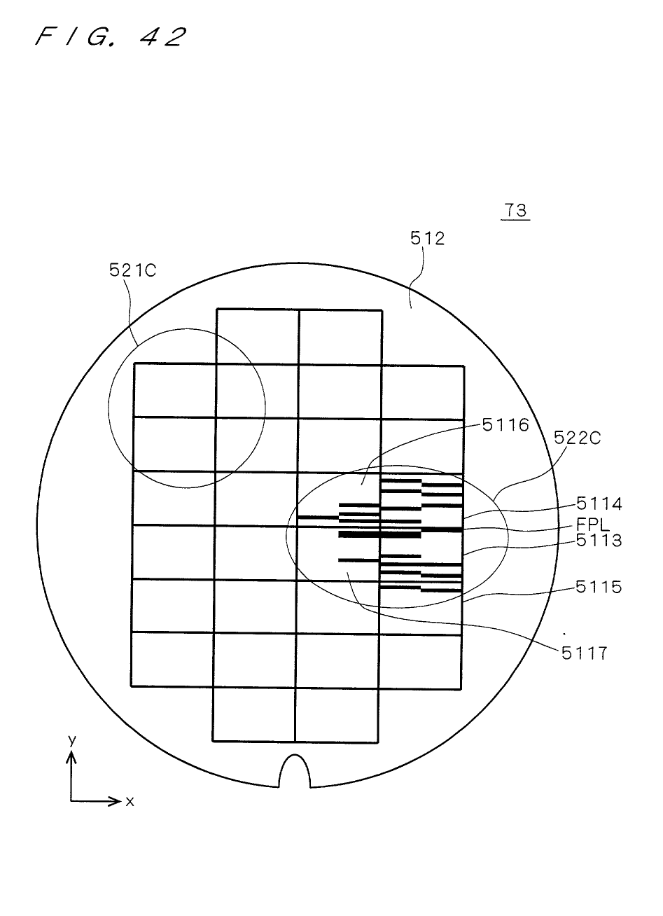

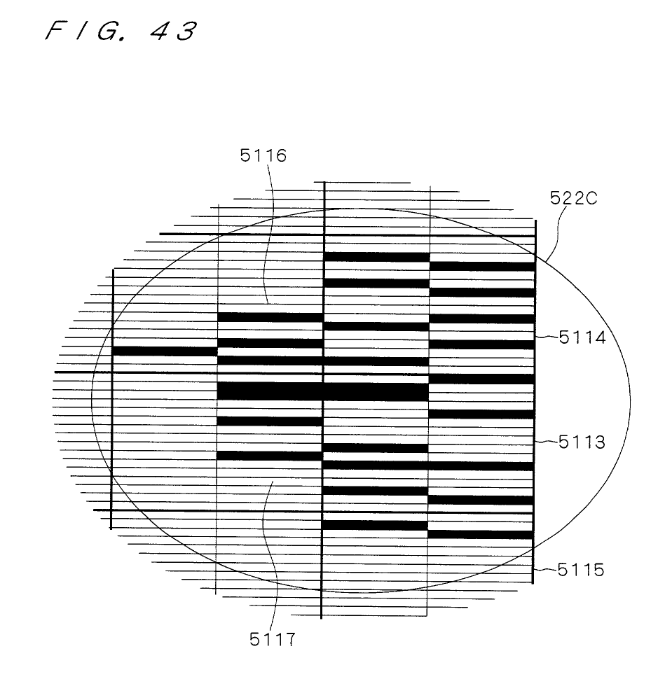

FIGS. 42 and 43 show the compressed FBM 73. When the original FBM 70 shown in FIG. 34 is compressed into areas each consisting of 16 bits in the x-direction and 1 bit in the y-direction and failure detection is performed every 12 bits of the compression threshold, although fail pixels (which are blackened) exist in an area 522C, no fail pixel exists in the an area 521C. The areas 521C and 522C are areas on the compressed FBM corresponding to the areas 521 and 522 in FIG. 34.

FIG. 43 shows the details of the area 522C in FIG. 42. A plurality of fail pixels FPL in stripes exist in the entire area of the semiconductor device 5113 and in the semiconductor devices 5114 to 5117 around the semiconductor device 5113.

Referring again to FIG. 37, at step ST95, whether the variable (m) reaches “2” as the number of compression times of FBM-2 or not is checked.

Since the number of compression times of FBM-2 does not reach “2”, “1” is added to the variable (m) at step ST100, and processes at step ST94 and subsequent steps are repeated.

By setting “2” as the variable (m), compression based under the compression condition FBM-2-2 is performed. At step ST94, the compressed FBM 73 shown in FIG. 42 is divided into the compressed areas (each consisting of 1×8 pixels) under the compression condition FBM-2-2 set at step ST91, and compression is further made on the basis of the set compression threshold (one pixel), thereby generating a repeatedly compressed FBM 74.

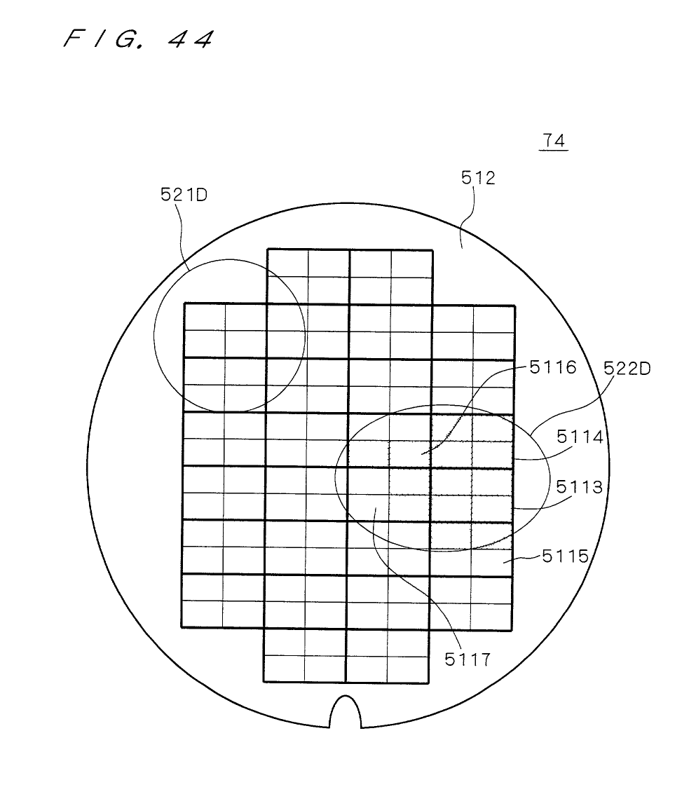

FIG. 44 shows the repeatedly compressed FBM 74. When the compressed FBM 73 shown in FIG. 42 is further compressed to areas each consisting of 1 pixel in the x-direction and 8 pixels in the y-direction, and failure detection is performed every pixel of the compression threshold, in an area 522D, fail pixels (which are hatched) exist densely in the entire area of the semiconductor device 5113 and in the semiconductor devices 5114 to 5117 around to the semiconductor device 5113. Obviously, there is no fail pixel in an area 521D.

The areas 521D and 522D are areas on the compressed FBM corresponding to the areas 521 and 522 in FIG. 34.

Referring again to FIG. 37, at step ST95, whether the variable (m) reaches 2 as the number of compression times of FBM-2 or not is checked.

Since the number of compression times of FBM-2 has reached 2, the program advances to step ST96 shown in FIG. 38. At step ST96, adjacent fail pixels existing within the adjacent fail pixel determining distance (one pixel) in the repeatedly compressed FBM 74 are grouped and extracted as a group of level 1 (inferior lines extending in the y-direction).

In this case, all of fail pixels in the area 522D are extracted as the group of level 2.

Level 2 denotes the result of performing the process with the variable (n) of 2 set at step ST101.

After steps ST94 to ST96 shown in FIGS. 37 and 38 are repeated and the series of grouping processes are finished, at step ST97, whether the variable (n) has reached “2” as the number of FBMs generated or not is checked.

Since the variable (n) is 2 which is the number of FBMs generated, the program advances to step ST98 where the involvement relation is checked every group of the extracted level, and an involved group is associated with an involving group.

In this case, since the group of level 1 and the group of level 2 do not have the involvement relation, an associating process is not performed.

At step ST99, the shape of fail bits is classified every extracted group.

For the classification of fail bit shapes on the group unit basis, the failure analysis method described in the first to fourth embodiments may be used. Other general failure analysis methods can be also used.

H-3. Action and Effect

In the failure analysis method of the seventh embodiment as described above, a plurality of compressed FBMs are generated by repeating the compressing process under the compression conditions in which the compression threshold and the compression area are varied, and pixels existing in a predetermined adjacent fail pixel determination distance are dealt as pixels belonging to the same group, thereby enabling areas having different fail pixel shapes to be grouped as different groups. After the areas are grouped, the involvement relation among groups is checked and the fail bit shapes are classified on the group unit basis, thereby enabling the cause of the failure to be effectively specified.

That is, since the cause in the case where a plurality of inferior lines occur in the x-direction and that in the case where a plurality of inferior lines occur in the y-direction are different from each other, the areas of different fail bit shapes can be grouped as different groups and the fail bit shapes are classified, thereby enabling the cause of a failure to be more accurately specified. By checking the involvement relation, the positional relation of areas of different fail bit shapes can be known, so that an effective source for determining the cause of a failure can be obtained.

I. Preferred Eighth Embodiment

The method of automatically obtaining a proper compression threshold on the basis of the shape of a fail bit pattern has been described in the fourth embodiment by using FIGS. 15 to 18. Since it is effective also in the fifth and sixth embodiments to obtain the compression threshold by the method, it will be described hereinbelow as the eighth embodiment.

The original FBM 50 shown in FIG. 21 will be described as an example. First, the original FBM 50 shown in FIG. 21 is divided into compression areas of predetermined values. The numerical values are, for example, 8×8 bits of each compression area set in the initial setting in the fifth embodiment described by using FIG. 30.

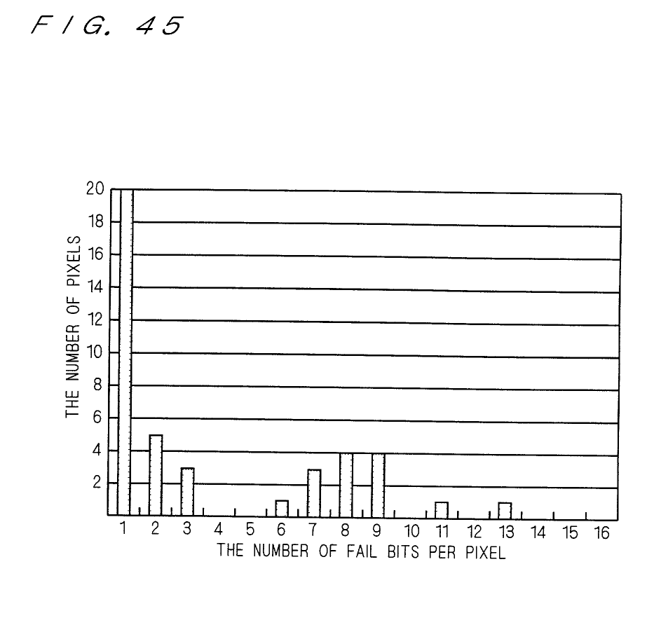

Subsequently, the number of fail bits per pixel (compression area) is counted. FIG. 45 shows a list of the number of fail bits in each pixel.

FIG. 45 is a graph having the lateral line indicating the number of fail bits included per pixel and the vertical line indicating the number of pixels. The number of pixels each including one fail bit is 20, the number of pixels each including two fail bits is 5, and the number of pixels each including three fail bits is 3. In such a manner, the number of pixels decreases and the number of pixels each including four or five fail bits is zero.

After that, the number of pixels increases as follows. The number of pixels each including six fail bits is 1, and the number of pixels each including seven fail bits is 3. From the graph, it is estimated that the fail bit existing characteristic is approximated by a quadratic curve in which the minimum value of the number of pixels is zero.

This characteristic is the same as that shown in FIG. 18. In a manner similar to the fourth embodiment, the compression threshold is calculated from the minimum value of the fail bit occurring characteristic. The compression threshold obtained by the method is four bits in this example.

Since the method of automatically obtaining the compression threshold on the basis of the data of the original FBM 50 is similar to that in the flow chart of FIG. 16, further explanation will be omitted. The action and effect is similar to that of the fourth embodiment.

J. Example 1 of Displaying Analysis Result

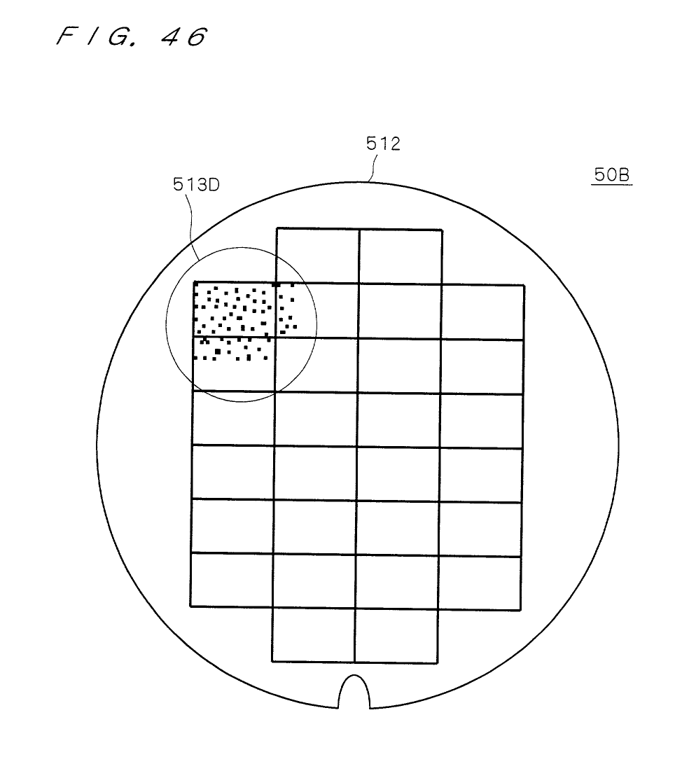

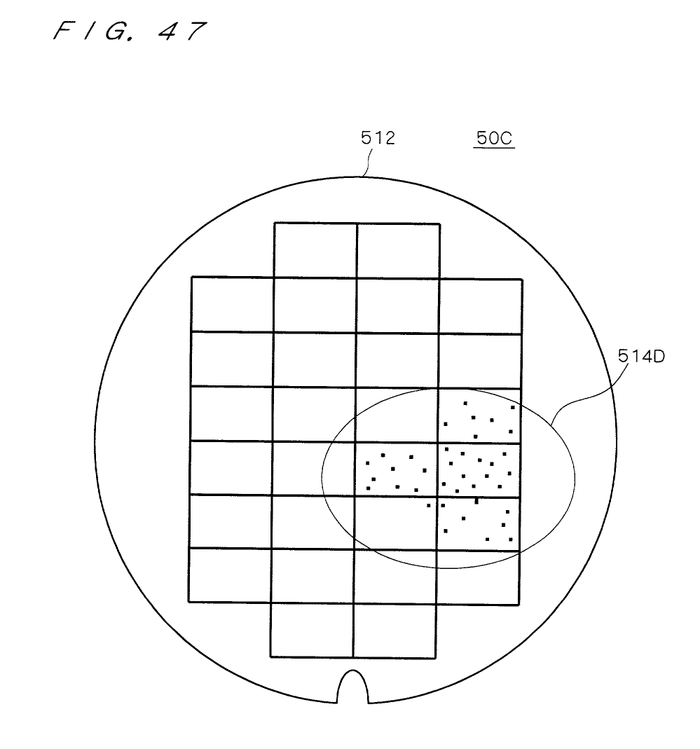

As the failure analysis methods described above in the fifth to seventh embodiments according to the invention, the methods of grouping areas of different fail bit densities or different fail bit shapes as different groups have been described. The obtained result may be displayed as shown in FIGS. 46 and 47.

FIGS. 46 and 47 show processed original FBMs 50B and 50C indicating the fail bit groups as groups of levels 1 and 2 in the fifth embodiment, respectively. Areas 513D and 514D shown in FIGS. 46 and 47 are areas on the processed original FBM corresponding to the areas 513 and 514 in FIG. 21, respectively.

By extracting and displaying the distribution of a fail bit group from the original FBM, the distribution of each fail bit group can be visually easily recognized.

K. Example 2 of Displaying Analysis Result

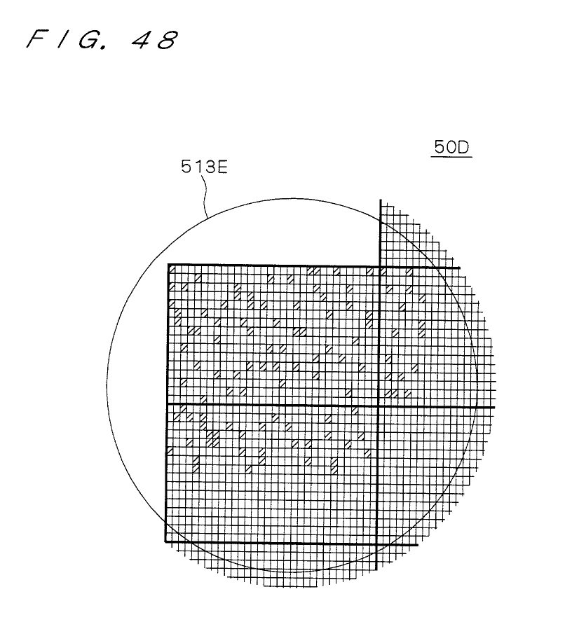

As an example of displaying the result of grouping, the result may be also displayed as shown in FIGS. 48 and 49.

FIGS. 48 and 49 are partial views showing the processed original FBM 50D in which failure groups extracted as groups of levels 1 and 2 in the fifth embodiment are colored by group (differently hatched in the diagram). Areas 513E and 514E shown in FIGS. 48 and 49 are areas on the processed original FBM corresponding to the areas 513 and 514 in FIG. 21.

By extracting distributions of failure groups from the original FBM, and coloring the failure groups by group, and simultaneously displaying the groups, the distributions of the failure groups can be more easily recognized visually. Such a display method is suitable for displaying failure groups having the involving and involved relations described in the fifth embodiment.

L. Example 3 of Displaying Analysis Result

In the failure analysis method described in the fifth to seventh embodiments of the invention, the areas of different fail bit densities or different fail bit shapes are grouped as different groups and the result is displayed as a processed FBM or compressed FBM. As will be described hereinbelow by using FIGS. 50 to 52, the areas may be displayed by graphs.

FIG. 50 shows area division 531 on a wafer used to calculate the failure groups. Areas R2 to R6 are provided in concentrical annular-shaped areas around an area R1 in the center of the wafer as a center. It is sufficient to set the length in the radius direction in each of the areas R1 to R6 as appropriate.

FIG. 51 is a graph showing the result of conducting the failure analysis described in the fifth to seventh embodiments on a plurality of wafers. The position of each of fail bits in the failure group extracted as a group of level 1 is shown in correspondence with the area division 531 shown in FIG. 50.

That is, FIG. 51 is a graph showing the number of existing fail bits constructing a failure group extracted as the group of level 1, in each of the areas R1 to R6, and shows the distribution of fail bits in each of the areas R1 to R6.

In FIG. 51, the area R4 has a peak of fail bits. It is understood that the center position of the failure group of level 1 exists in the area R4.

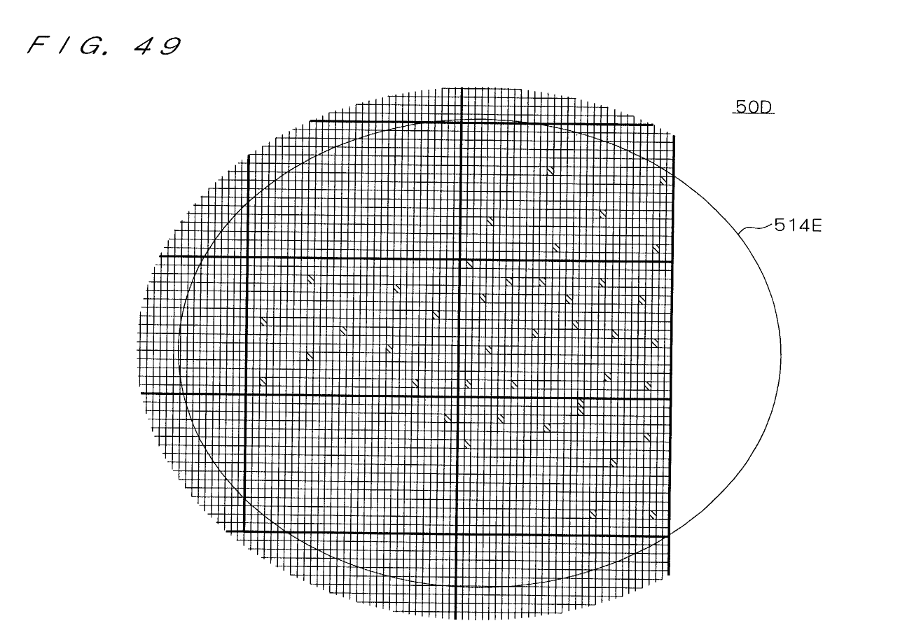

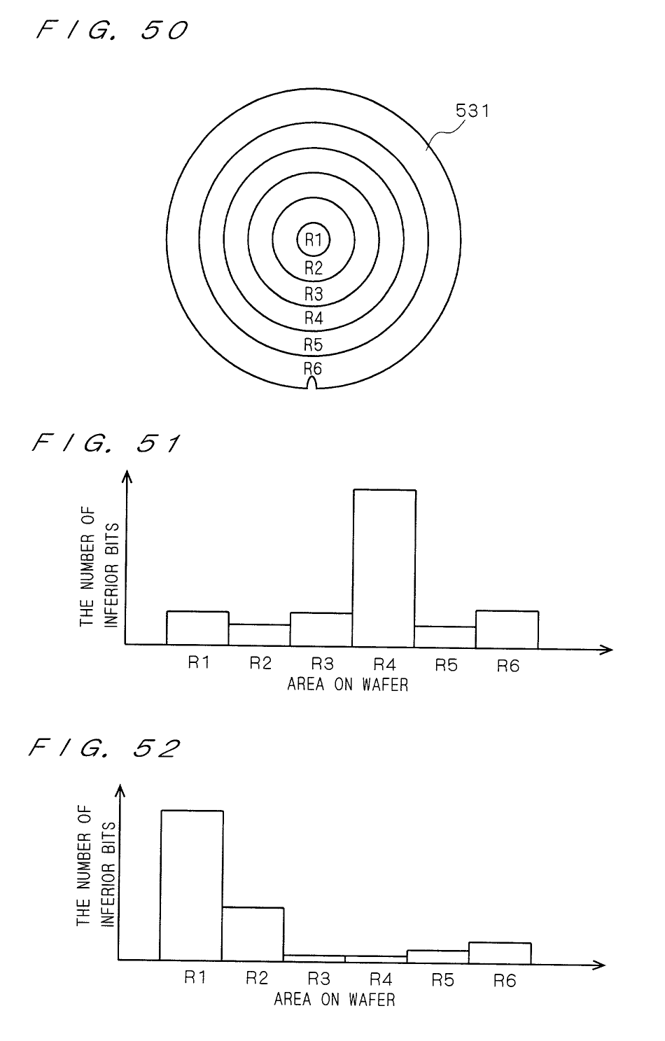

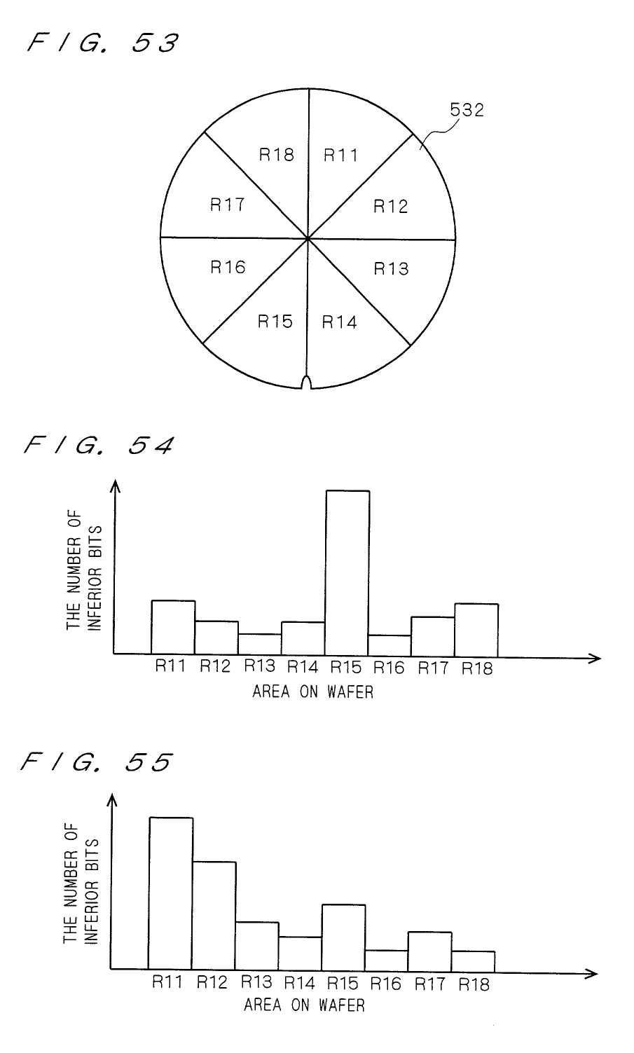

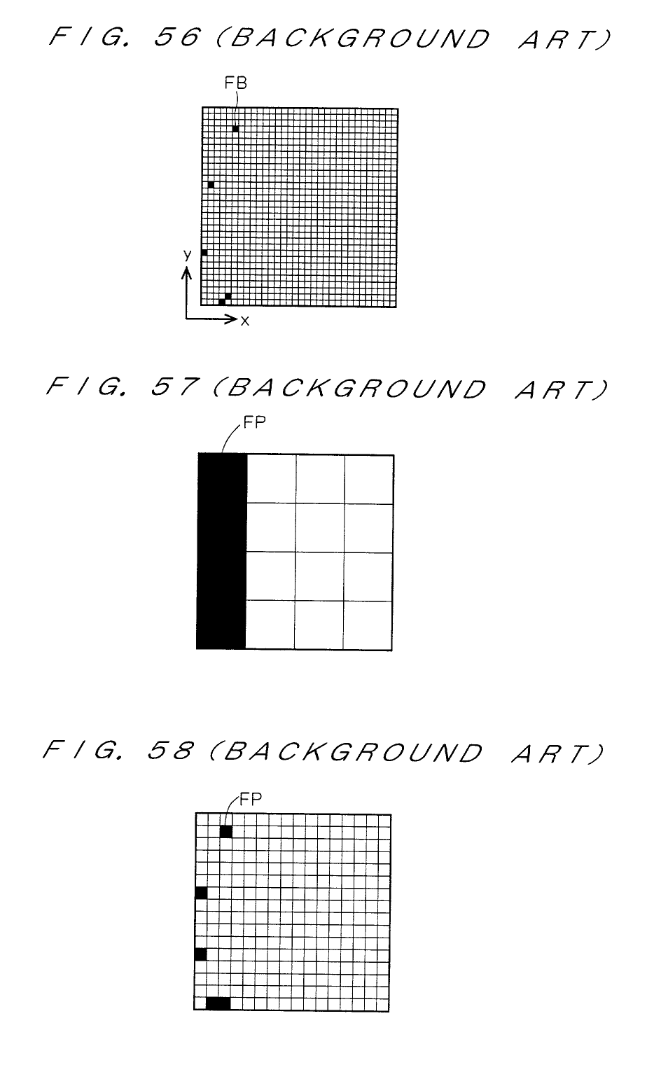

FIG. 52 is a diagram showing the position of a failure group extracted as a group of level 2 in correspondence with the area division 531 shown in FIG. 50, that is, a graph showing the number of fail bits existing in the areas R1 to R6, constructing the failure group extracted as the group of level 2.

In FIG. 52, it is understood that the area R1 has a peak of fail bits and the center position of the failure group of level 2 exists in the area R1.

By extracting the distribution of the failure group from the original FBM and showing the distribution state of the fail bits in each group in graph, the statistical distribution of the failure group can be visually recognized.

M. Example 4 of Displaying Analysis Result

As another example of displaying the result of grouping, a method described by using FIGS. 53 to 55 may be adopted.

FIG. 53 shows division 532 of areas on a wafer used to calculate a failure group. The wafer is radially divided into a plurality of areas R11 to R18 by using the wafer center as a center.

FIG. 54 is a graph of the results of failure analysis described in the fifth to seventh embodiments carried out on a plurality of wafers, and shows the positions of fail bits in the failure group extracted as the group of level 1 in correspondence with the area division 532 shown in FIG. 53.

That is, FIG. 54 is a graph showing the number of fail bits existing in each of the areas R11 to R18, constructing the failure group extracted as a group of level 1 to show a distribution of fail bits in the areas R11 to R18.

In FIG. 54, it is understood that the area R15 has a peak of the fail bits and the center position of the failure group of level 1 exists in the area R15.

FIG. 55 is a diagram showing positions of a failure group extracted as the group of level 2 in correspondence with the area division 532 shown in FIG. 53, that is, a graph showing the number of fail bits existing in each of the areas R11 to R18, constructing the failure group extracted as a group of level 2.

In FIG. 55, it is understood that the area R11 has a peak of the fail bits and the center position of the failure group of level 2 exists in the area R11.

By extracting the distribution of the failure group from the original FBM and showing the distribution state of the fail bits in each group in graph, the statistical distribution of the failure group can be visually recognized.

The area division on a wafer is not limited to the area divisions 531 and 532 shown in FIGS. 50 and 53. For example, a wafer may be divided in a square lattice state.

N. Example of Implementing Failure Analysis Method In a manner similar to the first to fourth embodiments, it is sufficient to use the computer system described with reference to FIG. 19 to implement the fifth to eighth embodiments of the failure analysis method according to the invention.

The failure analysis method according to the invention described by using the flow charts shown in FIGS. 23, 30, 37, and 38 can be implemented by running a computer program on a computer. In this case, the program (failure analysis program) is supplied on a recording medium such as the magnetic tape 104 or the CD-ROM 108. The program can be transmitted in the form of signals through a communication path and further downloaded to a recording medium.

A computer system on which the failure analysis program is loaded and which runs the program can be called a failure analyzer.

While the invention has been shown and described in detail, the foregoing description is in all aspects illustrative and not restrictive. It is therefore understood that numerous modifications and variations can be devised without departing from the scope of the invention.

What is claimed is:

1. A failure analysis method using an original fail bit map that is prepared, based on the data about the position of a failure memory cell having inferior electrical characteristic in a plurality of memory cells arranged in matrix form, by associating said failure memory cell with a fail bit in bit units, and mapping to the arrangement of said memory cells,
said failure analysis method comprising the steps of:
(a) preparing various compressed fail bit maps from said original fail bit map; and
(b) calculating fail rates of said respective compressed fail bit maps and distinguishing a fail shape based on said fail rates,
said compressed fail bit maps being prepared by the following steps: dividing said original fail bit map based on each of a plurality of compression areas having different size to convert into various forms in each of which a plurality of pixels of equal size to said their respective compression areas are arranged; and regarding said pixels containing said fail bit, as a fail pixel, and
said fail rates being defined by the ratio of said fail pixel in a predetermined region.

2. The failure analysis method according to claim 1 wherein said step (b) includes the steps of:
(b-1) by using as a reference fail rate said fail rate about one of said compressed fail bit maps, estimating a fail shape at least by collating a predetermined fail rate for distinguishing a fail shape with said reference fail rate;
(b-2) obtaining index values for fail shape judgement by standardizing said fail rates of the rest of said compressed fail bit maps by using said reference fail rate as a denominator; and
(b-3) collating said index values with a predetermined fail shape judgement rule to obtain a result, and distinguishing a fail shape based on said result and the result of the fail shape estimation in said step (b-1).

3. The failure analysis method according to claim 2 wherein,
said step (b) includes the step of judging whether said fail pixel in said predetermined region is adjacent to said fail pixel in a region other than said predetermined region, and
said step (b-1) performs a fail shape estimation based on the result of the collation between said predetermined fail rate and said reference fail rate, and the result of said judging step.

4. A failure analysis method using an original fail bit map that is prepared, based on the data about the position of a failure memory cell having inferior electrical characteristic in a plurality of memory cells arranged in matrix form, by associating said failure memory cell with a fail bit in bit units, and mapping to the arrangement of said memory cells,
said failure analysis method comprising the steps of:
(a) preparing various compressed fail bit maps from said original fail bit map; and
(b) calculating fail rates of said respective compressed fail bit maps and distinguishing a fail shape based on said fail rates,
said compressed fail bit maps being prepared by the following steps: dividing said original fail bit map based on a predetermined compression area to convert into such a form that a plurality of pixels of equal size to said compression area; judging based on each of a plurality of compression thresholds defining the number of said fail bits in said pixels whether said pixels are fail, and regarding said pixels containing a number of said fail bits corresponding to their respective compression thresholds, as a fail pixel, and
said fail rates being defined by the ratio of said fail pixel in a predetermined region.

5. The failure analysis method according to claim 4 wherein said step (b) includes the steps of:
(b-1) by using as a reference fail rate said fail rate about one of said compressed fail bit maps, estimating a fail shape by collating at least a predetermined fail rate for distinguishing a fail shape with said reference fail rate;
(b-2) obtaining index values for fail shape judgement by standardizing said fail rates of the rest of said compressed fail bit maps by using said reference fail rate as a denominator; and
(b-3) collating said index values with a predetermined fail shape judgement rule to obtain a result, and distinguishing a fail shape based on said result and the result of the fail shape estimation in said step (b-1).

6. The failure analysis method according to claim 5 wherein,
said step (b) includes the step of judging whether said fail pixel in said predetermined region is adjacent to said fail pixel in a region other than said predetermined region, and
said step (b-1) performs a fail shape estimation based on the result of the collation between said predetermined fail rate and said reference fail rate, and the result of said judging step.

7. A failure analysis method using an original fail bit map that is prepared, based on the data about the position of a failure memory cell having inferior electrical characteristic in a plurality of memory cells arranged in matrix form, by associating said failure memory cell with a fail bit in bit units, and mapping to the arrangement of said memory cells,
said failure analysis method comprising the steps of:
(a) preparing various compressed fail bit maps from said original fail bit map; and
(b) calculating fail rates of said respective compressed fail bit maps and distinguishing a fail shape based on said fail rates,
said compressed fail bit maps being prepared by the following steps: dividing said original fail bit map based on each of a plurality of compression areas having different size to convert into various forms in each of which a plurality of pixels of equal size to said their respective compression areas arranged; based on each of a plurality of compression thresholds defining the number of said fail bits in said pixel whether said pixels are fail, and regarding said pixels containing not less than a number of said fail bits corresponding to their respective compression thresholds, as a fail pixel, and
said fail rates being defined by the ratio of said fail pixel in a predetermined region.

8. The failure analysis method according to claim 7 wherein said step (b) includes the steps of:
(b-1) by using as a reference fail rate said fail rate about one of said compressed fail bit maps, estimating a fail shape by collating at least a preset predetermined fail rate for distinguishing a fail shape with said reference fail rate;
(b-2) obtaining index values for fail shape judgement by standardizing said fail rates of the rest of said compressed fail bit maps by using said reference fail rate as a denominator; and
(b-3) collating said index values with a predetermined fail shape judgement rule to obtain a result, and distinguishing a fail shape based on said result and the result of the fail shape estimation in said step (b-1).

9. The failure analysis method according to claim 8 wherein,
said step (b) includes the step of judging whether said fail pixel in said predetermined region is adjacent to said fail pixel in a region other than said predetermined region, and
said step (b-1) performs a fail shape estimation based on the result of the collation between said predetermined fail rate and said reference fail rate, and the result of said judging step.

10. A computer readable recording medium for recording a program that allows a computer to execute a failure analysis method according to claim 1.

11. A computer readable recording medium for recording a program that allows a computer to execute a failure analysis method according to claim 4.

12. A computer readable recording medium for recording a program that allows a computer to execute a failure analysis method according to claim 7.

13. A method of deriving a compression threshold used in a failure analysis method using an original fail bit map that is prepared, based on the data about the position of a failure memory cell having inferior electrical characteristic in a plurality of memory cells arranged in matrix form, by converting said failure memory cell with a fail bit in bit units, and mapping to the arrangement of said memory cells,
said method of deriving a compression threshold comprising the steps of:
(a) dividing said original fail bit map based on a predetermined compression area, and converting into such a form that a plurality of pixels of equal size to said compression area are arranged;
(b) counting, per said pixel, said fail bits in said pixels; and
(c) obtaining characteristic of existence of said fail bits that is expressed by the number of said pixels to the number of said fail bits in said pixels and, based on said characteristic of existence, thereby to calculate said compression thresholds.

14. The method of deriving compression thresholds according to claim 13 wherein said step (c) includes the step of taking count of pixels starting when the number of said fail bits is 1, and adopting, as a compression threshold, the number of said fail bits when the number of said pixels first reaches a minimum value.

15. A computer readable recording medium for recording a program that allows a computer to execute a method of deriving compression thresholds according to claim 13.

16. A failure analysis method using an original fail bit map that is prepared, based on the data about the position of a failure memory cell having inferior electrical characteristic in a plurality of memory cells arranged in matrix form, by associating said failure memory cell with a fail bit in bit units, and mapping to the arrangement of said memory cells,
said failure analysis method comprising the steps of:
(a) preparing compressed fail bit maps from said original fail bit map; and
(b) extracting said fail bits in a predetermined region in said compressed fail bit map as fail bits of the same group,
said compressed fail bit map being prepared by the following steps of: dividing said original fail bit map based on each of a plurality of compression areas each having a predetermined size to convert into a form in which a plurality of pixels of equal size to their compression areas are arranged; judging based on each of a plurality of compression thresholds defining the number of said fail bits in said pixels whether said pixels are fail, and regarding said pixels containing not less than a number of said fail bits corresponding to their respective compression thresholds, as a fail pixel, and
said step (a) includes the step of compressing said original fail bit map by using said compression threshold,
said predetermined region being defined by predetermined number of said pixels, and
said step (b) includes the step of judging said fail pixels in said predetermined number of pixels as pixels in the same group, and extracting said fail bits included in the group as bits in the same group.

17. The failure analysis method according to claim 16 further comprising the step of, after said step (b),
(c) preparing a processed original fail bit map by eliminating said fail bits extracted as said same group from said original fail bit map,
wherein said steps (a) to (c) are repeated predetermined number of times to extract said fail bits of other group, and
in the second and subsequent times, said step (a) prepares said compressed fail bit map based on said processed original fail bit map in place of said original fail bit map.

18. The failure analysis method according to claim 17, further comprising the step of displaying only said fail bit in said same group on a fail bit map.

19. The failure analysis method according to claim 17, further comprising the step of simultaneously displaying said fail bit in said same group and said fail bit in said other group in different display colors on a fail bit map.

20. The failure analysis method according to claim 17, wherein said failure analysis method is conducted on a plurality of wafers, and further comprises the step of dividing each of said plurality of wafers into a plurality of concentrical annular-shaped areas by using a wafer center portion as a center area and counting the number of said fail bits in said same group and that of said fail bits in said other group in each of said plurality of concentrical annular-shaped areas in each of said plurality of wafers.

21. The failure analysis method according to claim 17, wherein said failure analysis method is conducted on a plurality of wafers, and further comprises the step of radially dividing each of said plurality of wafers into a plurality of areas every predetermined angle by using a wafer center portion as a center and counting the number of said fail bits in said same group and that of said fail bits in said other group in each of said plurality of radial areas.

22. A computer readable recording medium for recording a program that allows a computer to execute a failure analysis method according to claim 16.

23. The failure analysis method according to claim 17, further comprising the step of
(c) checking an involvement relation between said fail bit included in said same group and said fail bit in said other group after repeating said steps (a) and (b) predetermined number of times,
wherein said step (c) includes the step of defining an involving group and an involved group by comparing coordinates of areas of forming said fail pixels constructing the groups in said compressed fail bit map.

24. The failure analysis method according to claim 23, further comprising the step of displaying only said fail bits in said same group on a fail bit map.

25. The failure analysis method according to claim 23, further comprising the step of simultaneously displaying said fail bits in said same group and said fail bits in said other group in different display colors on a fail bit map.

26. The failure analysis method according to claim 23, wherein said failure analysis method is conducted on a plurality of wafers, and further comprises the step of dividing each of said plurality of wafers into a plurality of concentrical annular-shaped areas by using a wafer center portion as a center area and counting the number of said fail bits in said same group and that of said fail bits in said other group existing in each of said plurality of concentrical annular-shaped areas of each of said plurality of wafers.

27. The failure analysis method according to claim 23, wherein said failure analysis method is conducted on a plurality of wafers, and further comprises the step of radially dividing each of said plurality of wafers into a plurality of areas every predetermined angle by using a wafer center portion as a center and counting the number of said fail bits in said same group and that of said fail bits in said other group in each of said plurality of radial areas in each of said plurality of wafers.

28. A computer readable recording medium for recording a program that allows a computer to execute a failure analysis method according to claim 23.

29. A failure analysis method using an original fail bit map that is prepared, based on the data about the position of a failure memory cell having inferior electrical characteristic in a plurality of memory cells arranged in matrix form, by associating a failure memory cell with a fail bit in bit units and mapping to the arrangement of said memory cells,
said failure analysis method comprising the steps of:
(a) preparing a compressed fail bit map from said original fail bit map;
(b) preparing a repeatedly compressed fail bit map by further compressing said compressed fail bit map predetermined number of times; and
(c) extracting said fail bits within a predetermined region in said repeatedly compressed fail bit map as fail bits of the same group,
said compressed fail bit maps being prepared by the following steps: dividing said original fail bit map based on a first compression area each having a predetermined size to convert into a form in which the first pixel of equal size to said first compression area are arranged; judging based on the first compression threshold defining the number of said fail bits in said first pixel whether said first pixel is fail, and regarding said first pixel containing not less than a number of said fail bits corresponding to said first compression thresholds, as a first fail pixel, and
said repeatedly compressed fail bit maps being prepared by the following steps: dividing said compression fail bit map based on a second compression area having a predetermined size; to convert into a form in which the second pixel of equal size to said second compression area are arranged; judging based on the second compression threshold defining the number of said first fail pixels in said second pixel whether said second pixel is fail, and regarding said second pixels containing not less than a number of said first fail pixels corresponding to said second compression thresholds, as a second fail pixel, and
said step (a) includes the step of compressing said original fail bit map by using said first compression area and said first compression threshold,
said step (b) includes the step of compressing said compressed fail bit map by using said second compression area and said second compression threshold,
said predetermined region being defined by the predetermined number of said second pixels, and
said step (c) includes the step of judging said second fail pixels existing within said predetermined number of pixels as pixels in the same group, and extracting said fail bits included in the group as bits in the same group.

30. The failure analysis method according to claim 29, further comprising the step of
(d) checking an involvement relation between said fail bit included in said same group and said fail bit in said other group after repeating said steps (a) to (c) preset number of times,
wherein said step (d) includes the step of defining an involving group and an involved group by comparing coordinates of areas of forming said second fail pixels constructing each of the groups in said repeatedly compressed fail bit map.

31. The failure analysis method according to claim 29, further comprising the step of displaying only said fail bits in said same group on a fail bit map.

32. The failure analysis method according to claim 29, further comprising the step of simultaneously displaying said fail bits in said same group and said fail bits in said other group in different display colors on a fail bit map.

33. The failure analysis method according to claim 29, wherein said failure analysis method is conducted on a plurality of wafers, and further comprises the step of dividing each of said plurality of wafers into a plurality of concentrical annular-shaped areas by using a wafer center portion as a center area and counting the number of said fail bits in said same group and that of said fail bits in said other group existing in each of said plurality of concentrical annular-shaped areas of each of said plurality of wafers.

34. The failure analysis method according to claim 29, wherein said failure analysis method is conducted on a plurality of wafers, and further comprises the step of radially dividing each of said plurality of wafers into a plurality of areas every predetermined angle by using a wafer center portion as a center and counting the number of said fail bits in said same group and that of said fail bits in said other group existing in each of said plurality of radial areas in each of said plurality of wafers.

35. A computer readable recording medium for recording a program that allows a computer to execute a failure analysis method according to claim 29.
